(19) United States
(12) Patent Application Publication
(10) Pub. No.: US 2026/0230660 A1
(43) Pub. Date: Aug. 6, 2026

(54) METHODS, DEVICES, AND COMPUTER PROGRAM FOR IMPROVING ENCAPSULATION OF ENCODED VOLUMETRIC DATA SUB-BITSTREAMS IN A SINGLE ENTITY

(71) Applicant: CANON KABUSHIKI KAISHA, Tokyo (JP)

(72) Inventors: Franck DENOUAL, SAINT DOMINEUC (FR); Lionel TOCZE, SAINT DOMINEUC (FR); Naël OUEDRAOGO, VAL D'ANAST (FR); MAZE Frédéric, LANGAN (FR)

(21) Appl. No.: 19/444,730

(22) Filed: Jan. 9, 2026

(30) Foreign Application Priority Data
Jan. 13, 2025 (GB) 2500432.6
Mar. 24, 2025 (GB) 2504301.9
Sep. 29, 2025 (GB) 2516148.0

(51) Int. Cl. H04N 21/2343; H04N 19/70

(52) U.S. Cl. CPC H04N 21/2343; H04N 19/70

(57) ABSTRACT

At least one embodiment of a method for encapsulating a visual volumetric data bitstream into a media file, in a processing device, the visual volumetric data bitstream comprising a plurality of encoded sub-bitstreams corresponding to a plurality of components of the visual volumetric data, the method comprising generating a single entity comprising the plurality of encoded sub-bitstreams, generating at least two decoder configuration data structures, and generating a media file comprising the generated single entity, the at least two decoder configuration data structures and an indication for indicating whether at least one of the decoder configuration data structures is associated with an encoded sub-bitstream comprised in the single entity based on association information.

### PRIORITY CLAIM

This application claims the benefit under 35 U.S.C. § 119 (a)-(d) of United Kingdom Patent Application No. 2500432.6, filed on Jan. 13, 2025 and entitled “methods, devices, and computer program for improving encapsulation of encoded volumetric data sub-bitstreams in a single track”, United Kingdom Patent Application No. 2504301.9, filed on Mar. 24, 2025 and entitled “methods, devices, and computer program for improving encapsulation of encoded volumetric data sub-bitstreams in a single track”, and United Kingdom Patent Application No. 2516148.0, filed on Sep. 29, 2025 and entitled “methods, devices, and computer program for improving encapsulation of encoded volumetric data sub-bitstreams in a single entity”. The above cited patent applications are incorporated herein by reference in their entirety.

### FIELD OF THE DISCLOSURE

The present disclosure relates to the technical field of encapsulation of visual volumetric data, in particular of a visual volumetric data bitstream comprising encoded sub-bitstreams, in a single entity such as a single track or a single item.

### BACKGROUND OF THE DISCLOSURE

Part-5 of the international standard for Coded representation of immersive media (MPEG-I), called “Visual volumetric video-based coding (V3C) and video-based point cloud compression (V-PCC)” specifies a generic mechanism for visual volumetric video coding, i.e. visual volumetric video-based coding. This standard is commonly denoted ISO/IEC 23090-5 or MPEG-I Part 5. In short, MPEG-I Part-5 defines V3C bitstreams. A V3C bitstream (i.e., a visual volumetric video-based coding bitstream) is a sequence of bits that forms the representation of coded volumetric frames and associated data forming one or more Coded V3C Sequences (CVSs). The generic mechanism may be used by applications targeting volumetric content, such as point clouds, immersive video with depth, mesh representations of visual volumetric frames, etc. MPEG-I Part-5 also comprises specific definitions dedicated to point clouds called V-PCC for Video-based Point Cloud Compression. A second part of MPEG-I, Part-12 (ISO/IEC 23090-12) is directed to volumetric media encoded as MPEG Immersive Video (MIV) that can also be described within the generic V3C bitstream structure.

Another part (Part-29, under definition) of the international standard for Coded representation of immersive media (MPEG-I), called “Video-based dynamic mesh coding (V-DMC)” specifies syntax, semantics, and decoding for video based dynamic mesh coding (V-DMC) methods. Furthermore, Part-29 specifies processes that may be needed for reconstruction of visual volumetric media and may also specify additional processes such as post decoding, pre-reconstruction, post reconstruction, and adaptation. In short, Part-29 defines V-DMC bitstreams. The syntax and semantics for the Part-29 are specified as an extension of Part-5.

While a V3C bitstream mixes several kinds of bitstreams or sub-bitstreams (corresponding to different components), for example atlas sub-bitstreams with video sub-bitstreams (for geometry, attributes and occupancy), V-DMC is defining additional types of bitstreams or sub-bitstreams, thus requiring modifications in the V3C bitstream description and additional parameters to provide additional items of information to media players and decoders. For the sake of illustration, V-DMC is considering two additional sub-bitstreams, respectively a base-mesh (or basemesh) sub-bitstream (or component) and a displacement sub-bitstream. The base-mesh sub-bitstream is a simplified low-resolution approximation of the original mesh, and the displacement sub-bitstream provides displacement vectors, to refine the base mesh to better fit the original mesh. Encoding of the displacement sub-bitstream is specified either using any video codec (such as HEVC (High Efficiency Video Coding), VVC (Versatile Video Coding) for example) or arithmetic codec. For the base-mesh sub-bitstream, the V-DMC specification introduces a new bitstream format. This new bitstream format, as for video coding format such as HEVC or the atlas sub-bitstream used in V3C, also uses NAL (Network Abstraction Layer) units. High Level Syntax (HLS) structures or syntax structures such as base-mesh sequence parameter sets (BMSPS), base-mesh frame parameter sets (BMFPS), or a sub-mesh layer raw byte sequence payload (RBSP) syntax structure representing the content of some of the NAL units of a V-DMC bitstream are also specified.

In addition to the coding standards, standard ISO/IEC 14496-12, defining the ISO Base Media File Format (ISOBMFF), allows creating files that encapsulate media data with metadata. Such encapsulated files may be called presentations. Within a presentation, media data are generally represented as tracks. A track is a timed sequence of related samples, a sample corresponding to the data associated with a single time or period of time. ISOBMFF provides a sample description, mainly through sample entry. A sample entry is a box structure which defines and describes the format of some number of samples in a track. A sample entry usually contains a configuration box providing information for decoder initialization, sometimes called “decoder configuration” or “decoder initialisation”.

The ISO/IEC 23008-12 standard, defining the Image File Format (or High Efficiency Image File format-HEIF), is built on tools defined in ISO/IEC 14496-12 and allows creating files that encapsulate media data with metadata for single image, a collection of images and sequences of images. The media data are generally represented as entities that can be either tracks or items. An item is data that does not require timed processing, as opposed to sample data, and is described by the boxes contained in a MetaBox box. HEIF provides a description about an item in item property array. The item properties are stored in a box structure which may describes the format of one or more items in a the HEIF file. For example, the item properties may contain a configuration box or decoder configurations for the items.

Another derived specification of ISO/IEC 14496-12, known as ISO/IEC 23090-10, defines the carriage of timed visual volumetric video-based coding data defined either by MPEG-I part 5 or part 29. In particular, two sections describe single-track encapsulation and the specific ISOBMFF structures applicable to add in metadata description of the ISOBMFF file.

More precisely, a description dedicated to carriage of data encoded with V-PCC or MIV, defines structures such as V3CBitstreamSampleEntry (with different four-character codes (4CC) such as ‘v3e1’, ‘3eg’, etc.), which should contain at least a V3CConfigurationBox (also noted with 4cc ‘v3cC’) and another description dedicated to carriage of data encoded with V-DMC, defines structures such as V3CBitstreamSampleEntry (with different 4CC types such as ‘vdm1’, ‘vdmg’), which should contain at least the following specific decoder configuration boxes:
one V3CConfigurationBox (‘v3cC’),
one VDMCBaseMeshConfigurationBox (‘vbmC’), and
one optional VDMCDisplacementConfigurationBox (‘vdcC’).

In V3CBitstreamSampleEntry, some additional sample entries may be added, to describe any encoded video sub-bitstream, such as HEVCSampleEntry (‘hvc1’ or ‘hev1’) containing an HEVCConfigurationBox (‘hvcC’), VvcSampleEntry (‘vvc1’ or ‘vvi1’) containing an VvcConfigurationBox (vvcC’) or any other video sample entry described in ISO/IEC 14496-15.

### SUMMARY OF THE DISCLOSURE

There exist circumstances in which media data should be encapsulated in a single-track ISOBMFF file of a bitstream composed of several sub-bitstreams that are encoded with different codecs. In such circumstances, there is a need to improve encapsulation so as to make parsing and decoding more efficient.

The present disclosure has been devised to address one or more of the foregoing concerns.

According to a first aspect of the disclosure, there is provided a method for encapsulating a visual volumetric data bitstream into a media file, in a processing device, the visual volumetric data bitstream comprising a plurality of encoded sub-bitstreams corresponding to a plurality of components of the visual volumetric data, the method comprising:
generating a single entity comprising the plurality of encoded sub-bitstreams;
generating at least two decoder configuration data structures and
generating a media file comprising the generated single entity, the at least two decoder configuration data structures and an indication for indicating whether at least one of the decoder configuration data structures is associated with an encoded sub-bitstream comprised in the single entity based on association information.

Accordingly, the method of the disclosure makes it possible to improve encapsulation so as to make parsing and decoding more efficient, in particular to improve initialization of decoders.

According to some embodiments, the indication further indicates whether each of the decoder configuration data structures is associated with an encoded sub-bitstream of the plurality, based on a predetermined order depending on a type of the encoded sub-bitstream, such that the indication indicates whether each of the decoder configuration data structures is associated with an encoded sub-bitstream of the plurality based on association information or on a predetermined order depending on a type of the encoded sub-bitstream.

According to some embodiments, the media file further comprises an association structure comprising the association information for associating at least one of the at least two decoder configuration data structures with an encoded sub-bitstream of the plurality.

According to some embodiments, the association information comprises an index of a decoder configuration data structure associated with a header of the visual volumetric data bitstream describing a sub-bitstream.

According to some embodiments, the indication for indicating that the at least one decoder configuration data structure is associated with an encoded sub-bitstream based on association information is the presence of the association structure.

According to some embodiments, the single entity is a track and the association information is comprised in the track.

According to some embodiments, the at least two decoder configuration data structures and the association structure are comprised in a sample entry of the track.

According to some embodiments, the single entity is an item and the association information is associated with the item.

According to some embodiments, the item is associated with a plurality of decoder configuration data structures and the association structure as item properties.

According to some embodiments, the media file is an ISOBMFF media file.

According to a second aspect of the disclosure, there is provided a method of processing a media file encapsulating a visual volumetric data bitstream, in a processing device, the visual volumetric data bitstream comprising a plurality of encoded sub-bitstreams corresponding to a plurality of components of visual volumetric data of the visual volumetric data bitstream, the method comprising:
obtaining, from the media file,
   (i) a single entity comprising the plurality of encoded sub-bitstreams,
   (ii) at least two decoder configuration data structures and
   (iii) an indication for indicating whether at least one of the decoder configuration data structures is associated with an encoded sub-bitstream comprised in the single entity based on association information and
associating decoder configuration data to each sub-bitstream of the plurality based on the obtained at least two decoder configuration data structures and the obtained indication.

Accordingly, the method of the disclosure makes it possible to make parsing and decoding more efficient, in particular to improve initialization of decoders.

According to some embodiments, the indication further indicates whether each of the decoder configuration data structures is associated with an encoded sub-bitstream of the plurality, based on a predetermined order depending on a type of the encoded sub-bitstream, such that the indication indicates whether each of the decoder configuration data structures is associated with an encoded sub-bitstream of the plurality based on association information or on a predetermined order depending on a type of the encoded sub-bitstream.

According to some embodiments, the method further comprises obtaining, from the media file, an association structure comprising the association information for associating at least one of the two decoder configuration data structures with an encoded sub-bitstream of the plurality.

According to some embodiments, the indication for indicating that the at least one decoder configuration data structure is associated with an encoded sub-bitstream based on association information is the presence of the association structure.

According to some embodiments, the single entity is a track and the association information is comprised in the track.

According to some embodiments, the at least two decoder configuration data structures and the association structure are comprised in a sample entry of the track.

According to some embodiments, the single entity is an item and the association information is associated with the item.

According to some embodiments, the item is associated with a plurality of decoder configuration data structures and the association structure as item properties.

According to some embodiments, the media file is an ISOBMFF media file.

According to a third aspect of the disclosure, there is provided a media file encapsulating a visual volumetric data bitstream, the visual volumetric data bitstream comprising a plurality of encoded sub-bitstreams corresponding to a plurality of components of the visual volumetric data, the media file comprising a single entity, the single entity comprising a plurality of encoded sub-bitstreams, the media file further comprising at least two decoder configuration data structures and an indication for indicating whether at least one of the decoder configuration data structures is associated with an encoded sub-bitstream based on association information.

Accordingly, the media file of the disclosure makes it possible to make parsing and decoding more efficient, in particular to improve initialization of decoders.

According to another aspect, there is provided a method of encapsulating media data into a media file, the media data comprising base data and additional data to the base data, the method comprising:
generating a track comprising a sequence of samples, each sample being associated with a single time, each sample comprising:
   a first part including data of the base data associated with the single time and
   at least one additional part including data of the additional data associated with the single time,
generating descriptive metadata including information relative to the organization of the at least one additional part of the samples in the track;
generating the media file comprising the generated track and the descriptive metadata.

Thus, the entire bitstream is described in the media file in terms of samples, so that the tools for sample description remain available: subsample, sample groups and sample auxiliary information remain the same. This means that without additional signalling, any description of the sample (like sample groups, subsample or sample auxiliary information) is done on the complete reaggregated sample (base data and additional data, also called “full” sample) These tools stay the same, and allow a media file reader to “thin” the media file by fetching only the parts of samples it requires. If performing sample thinning, a file reader may have to edit these descriptions accordingly, i.e. remove descriptions corresponding to parts of the file that have been removed by the thinning process to keep the sample descriptions backward compatible. Indeed, backward compatibility is possible as long as none of these description structures include byte ranges from the additional split layers (the additional parts).

Therefore, the present disclosure makes possible to describe, in a single track, a base configuration for basic players for parsing base data, with additional configurations for advanced players or readers for parsing base data with additional data. It has no extractors-like constructs and keeps the original ISOBMFF design for base data (or base split layer).

In an embodiment, the base data correspond to data associated with a first coding type sub-bitstream and the additional data correspond to data associated with at least one other coding type sub-bitstream.

In an embodiment, the first coding type sub-bitstream and the at least one other coding type sub-bitstream are chosen between:
an atlas sub-bitstream,
a base mesh sub-bitstream containing base mesh data providing information on a simplified mesh of a 3D content, or
an arithmetic displacement sub-bitstream containing data describing displacement information, to apply to points described by the simplified base mesh, or
a video sub-bitstream.

In an embodiment, the video sub-bitstream is chosen between an occupancy video sub-bitstream, a geometry video sub-bitstream and an attribute video sub-bitstream.

In an embodiment, the information relative to the organization of the at least one additional part of the samples in the track comprises configuration information for the organization of the at least one other coding type sub-bitstream in the track and size information for the size of the at least one other coding type sub-bitstream samples.

In an embodiment, the descriptive metadata comprises decoder configuration for the first coding type sub-bitstream and at least one decoder configuration for the at least one other coding type sub-bitstream.

In an embodiment, the decoder configurations of the first coding type sub-bitstream and of the at least one other coding type sub-bitstream are stored in a base split layer sample entry in a sample table box included in a track box of the media file.

In an embodiment, the base split layer sample entry includes a decoder configuration box including decoder configuration for initializing a decoder to decode the first coding type sub-bitstream.

In an embodiment, the base split layer sample entry includes a split sample descriptions box, comprising decoder configuration of the at least one other coding type sub-bitstream.

In an embodiment, the split sample descriptions box includes a sample entry comprising decoder configuration for initializing a decoder to decode the base mesh sub-bitstream.

In an embodiment, the split sample descriptions box includes a sample entry comprising decoder configuration for initializing a decoder to decode a geometry video sub-bitstream, that provides displacement information applicable to the base mesh.

In an embodiment, the split sample descriptions box includes a sample entry comprising decoder configuration for initializing a decoder to decode a video codec sub-bitstream.

In an embodiment, the split sample descriptions box, comprises a box comprising information to identify the coding type of the at least one other coding type sub-bitstream.

In an embodiment, the sample table box includes a split sample sizes box including, for each other coding type sub-bitstream, a sample size box indicating the sizes of the different other coding type sub-bitstream samples.

In an embodiment, the first coding type sub-bitstream and the at least one other coding type sub-bitstream are stored in different chunks in a media data box. The sample table box includes a split chunk offset box comprising, for each other coding type sub-bitstream, a box indicating an offset of a chunk in the media data, where a sample of the other coding type sub-bitstream is contained.

In an embodiment, the base split layer sample entry includes a box comprising information to identify the coding type of the first coding type sub-bitstream.

According to another aspect, there is provided a method of parsing a media file including:
a track comprising a sequence of samples, each sample being associated with a single time, each sample comprising:
   a first part including data of base data associated with the single time and
   at least one additional part including data of additional data associated with the single time,
descriptive metadata including information relative to the organization of the at least one additional part of the samples in the track;
wherein the method comprises a reconstruction of the samples based on the first part of the samples only or based on an aggregation of the first part of the samples with the at least one additional part of the samples according to said descriptive metadata.

According to another aspect, there is provided a computer program product for a programmable apparatus, the computer program product comprising a sequence of instructions for implementing a method of encapsulating media data into a media file or a method of parsing a media file as previously described, when loaded into and executed by the programmable apparatus.

According to another aspect, there is provided a computer-readable storage medium storing instructions of a computer program product as previously described.

According to another aspect, there is provided a device for encapsulating media data into a media file, the media data comprising base data and additional data to the base data, the device comprising a processor configured to:
generate a track comprising a sequence of samples, each sample being associated with a single time, each sample comprising:
   a first part including data of the base data associated with the single time and
   at least one additional part including data of the additional data associated with the single time,
generate descriptive metadata including information relative to the organization of the at least one additional part of the samples in the track;
generate the media file comprising the generated track and the descriptive metadata.

According to another aspect, there is provided a device for parsing a media file including:
a track comprising a sequence of samples, each sample being associated with a single time, each sample comprising:
   a first part including data of base data associated with the single time and
   at least one additional part including data of additional data associated with the single time,
descriptive metadata including information relative to the organization of the at least one additional part of the samples in the track;
wherein the device comprises a processor configured to reconstruct the samples based on the first part of the samples only or based on an aggregation of the first part of the samples with the at least one additional part of the samples according to said descriptive metadata.

According to another aspect, there is provided a media file including:
a track comprising a sequence of samples, each sample being associated with a single time, each sample comprising:
   a first part including data of base data associated with the single time and
   at least one additional part including data of additional data associated with the single time,
descriptive metadata including information relative to the organization of the at least one additional part of the samples in the track.

A basic player (notably a basic parser) can process such media file. In particular, the basic player can process the base bitstream and can ignore unknown boxes related to the at least one additional part of the samples and by processing boxes from regular sample description related to the first part of the samples.

The data organization of the sample parts preserves encryption, sample grouping description, subsample information.

According to other aspects of the disclosure, there is provided a processing device comprising a processing unit configured for carrying out each step of the methods described above. The other aspects of the present disclosure have optional features and advantages similar to the first and second above-mentioned aspects.

At least parts of the methods according to some embodiments of the disclosure may be computer implemented. Accordingly, some embodiments of the present disclosure may take the form of an entirely hardware embodiment, an entirely software embodiment (including firmware, resident software, micro-code, etc.) or an embodiment combining software and hardware aspects that may all generally be referred to herein as a “circuit”, a “module”, or a “system”. Furthermore, some embodiments of the present disclosure may take the form of a computer program product embodied in any tangible medium of expression having computer usable program code embodied in the medium.

Since some embodiments of the present disclosure can be implemented in software, some embodiments of the present disclosure can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device, and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Other features and advantages of the disclosure will become apparent from the following description of non-limiting exemplary embodiments, with reference to the appended drawings, in which:

FIG. 1 schematically illustrates encapsulating and parsing volumetric media presentations, according to some embodiments of the disclosure;

FIG. 2 illustrates an example of steps of an encapsulation process according to some embodiments of the disclosure;

FIG. 3 illustrates an example of steps of a parsing process according to some embodiments of the disclosure, in order to decode the content of a media file;

FIG. 4 illustrates a first example of a media file obtained after carrying out an encapsulation process according to some embodiments of the disclosure;

FIG. 5a illustrates a second example of a media file obtained after carrying out an encapsulation process according to some embodiments of the disclosure;

FIGS. 5b and 5c illustrate how a decoder mapping may apply to single V3C items;

FIG. 6 illustrates a third example of a media file obtained after carrying out an encapsulation process according to some embodiments of the disclosure; and

FIG. 7 illustrates a fourth example of a media file obtained after carrying out an encapsulation process according to some embodiments of the disclosure; and

FIG. 8 schematically illustrates a processing device configured to implement at least a part of one or more embodiments of the present disclosure.

### DETAILED DESCRIPTION OF EMBODIMENTS OF THE DISCLOSURE

According to some embodiments of the disclosure, a solution is provided to determine and signal without ambiguity the decoder configurations to apply to a bitstream and to any of its sub-bitstreams. In a single-track encapsulation mode and still according to some embodiments of the disclosure, each decoder configuration is described only once in the sample entry.

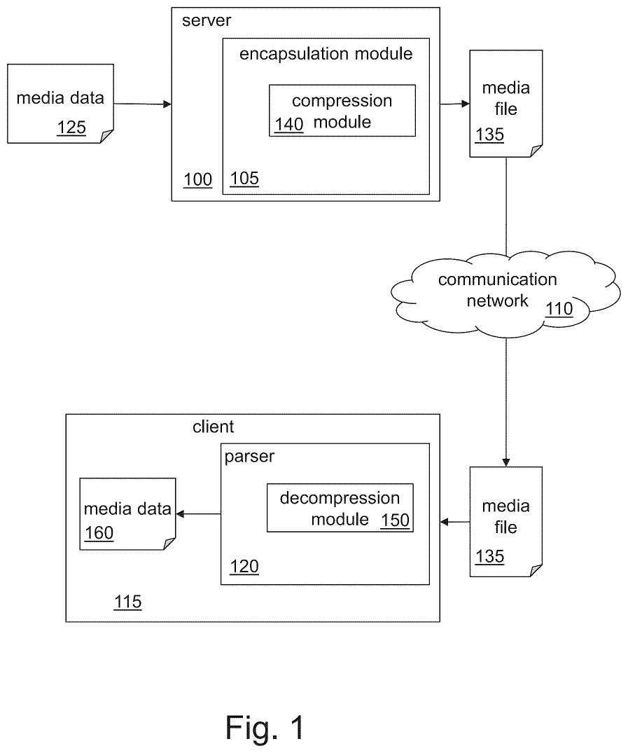

System for encapsulating and parsing volumetric media presentations FIG. 1 schematically illustrates encapsulating and parsing volumetric media presentations, according to some embodiments of the disclosure.

As illustrated, a server 100 comprises an encapsulation module 105. The server 100 may be connected, via a network interface (not represented), to a communication network 110 to which is also connected, via a network interface (not represented), a client 115 comprising a parser (or de-encapsulation module) 120 or a storage device (not represented).

According to the given example, server 100 processes media data 125, for example data representing a 3D sequence, for streaming or for storage. Media data 125 may correspond to a set of items of information representing positions of points in the space and different attributes (for example Texture attribute) to apply at each position. The positions of points may be provided either as video images representing geometry, occupancy and attributes for V-PCC or as a set of 3D points and attributes for V-DMC, the 3D points corresponding for example to vertices of polygons forming a 3D mesh. If media data 125 are not coded, in particular not compressed, they are called raw or uncompressed data. Media data 125 may be encoded using different compression methods, for example V-PCC or V-DMC (3D point cloud or mesh) methods. These compression methods use a V3C bitstream format, including several sub-bitstreams using video or dedicated codecs, for example as specified respectively in the ISO/IEC 23090-5 standard (for V-PCC) or in the ISO/IEC 23090-29 standard (for V-DMC). If media data 125 are encoded, they are called compressed bitstream data.

The encoding may be done within server 100, for example by compression module 140, or may be done remotely (i.e., outside the server) in which case the media data 125 are provided in a compressed bitstream. Server 100 may encapsulate media data 125 into media file 135 or into segment files (containing one or more segments), as they are processed, for example for live recording or live transmission. The media file or the segment files comprise the encoded media data and an index or description of media data 125. This index or description comprises items of information allowing locating samples in time, determining their type and determining their size, (data) container, and offset into the container.

Media file 135 (or the generated segment files) may be stored in a local or remote storage device or may be transmitted to a client, for example to client 115.

Client 115 may be configured to process data received from communication network 110, for example to process media file 135, or to process encapsulated data read from a storage device. After the received or the read data have been parsed in parser 120 (also known as a de-encapsulation module or a reader, or even a player or a media player), the parsed data may be stored, displayed or output. According to the given example, the parser outputs the media data referenced 160, as encoded volumetric bitstream. Depending on the configuration and on the capabilities of the client 115, in particular whether decompression module 150 is present, media data 160 may correspond to decoded 3D media content 125, representing position of points in space and the different attributes.

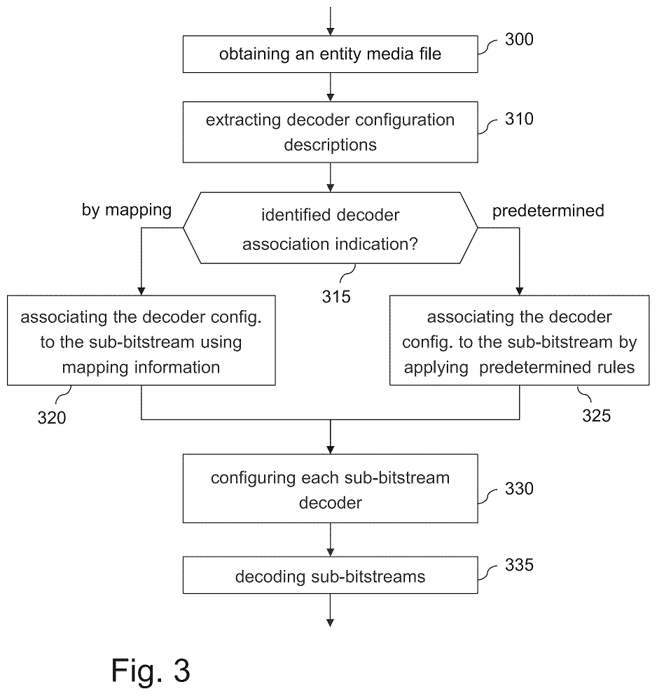

It is observed that since an encoded volumetric bitstream may be composed of several sub-bitstreams using different encoders, decompression module 150 in client 115 requires to instantiate several types of encoders to process the data contained in the media file 135. This requires decompression module 150 to identify the number of decoders and their configurations to generate decoded 3D media content 160, corresponding to media data 125. An example of steps for decompressing all the sub-bitstreams is described by reference to FIG. 3.

It is observed that server 100 and client 115 may be user devices but may also be network nodes acting on media files being transmitted or stored.

It is also noted that media file 135 received or read by client 115 may be communicated to parser 120 in different ways. In particular, encapsulation module 105 may generate media file 135 with a media description (e.g., a DASH MPD, i.e. a media presentation description (MPD) of the dynamic adaptive streaming over HTTP (DASH) protocol) and communicate (or stream) it directly to parser 120 upon receiving a request from client 115. Media file 135 may also be downloaded, at once or progressively, by client 115 and stored locally.

For the sake of illustration, media file 135 may encapsulate media data into boxes according to ISO Base Media File Format (ISOBMFF, ISO/IEC 14496-12) or Image File Format (HEIF, ISO/IEC 23008-12).

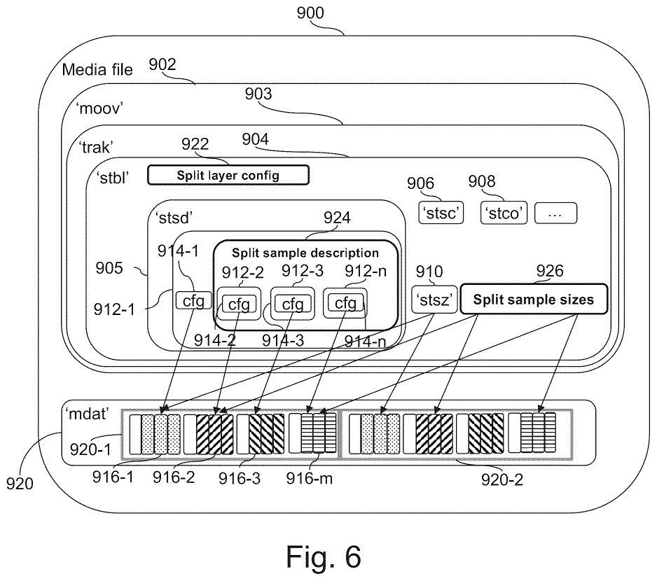

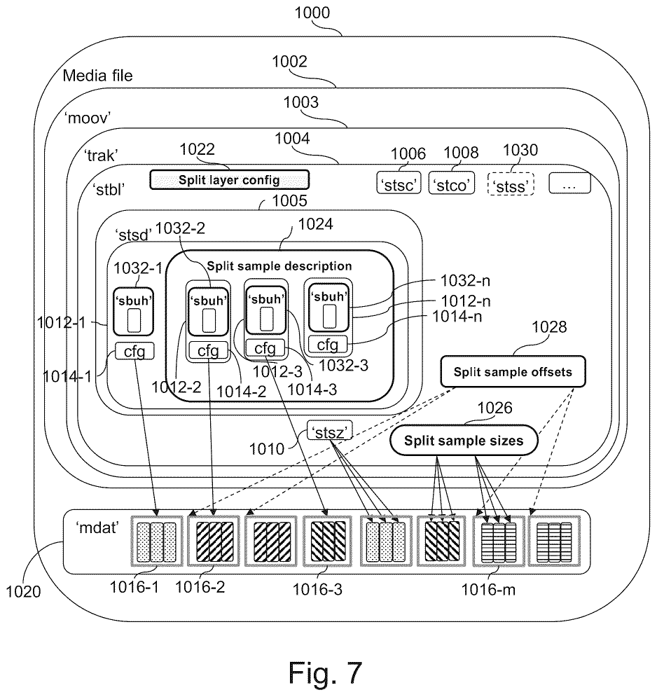

In such a case, media file 135 may correspond to one or several media files or segments (indicated by a FileTypeBox ‘ftyp’ or a SegmentTypeBox ‘styp’). According to ISOBMFF or HEIF, media file 135 may include two kinds of boxes, one or several “media data boxes” (e.g. ‘mdat’ or ‘imda’), containing the media data, and “metadata boxes” or “structure-data wrapper” (e.g. ‘moov’ or ‘moof’ or ‘meta’), containing metadata defining the position of the media data in the media data box(es) and temporal position (if any) of the media data. Different embodiments of encapsulation of compressed bitstream data are described by reference to FIGS. 6 and 7.

### Encapsulation Process

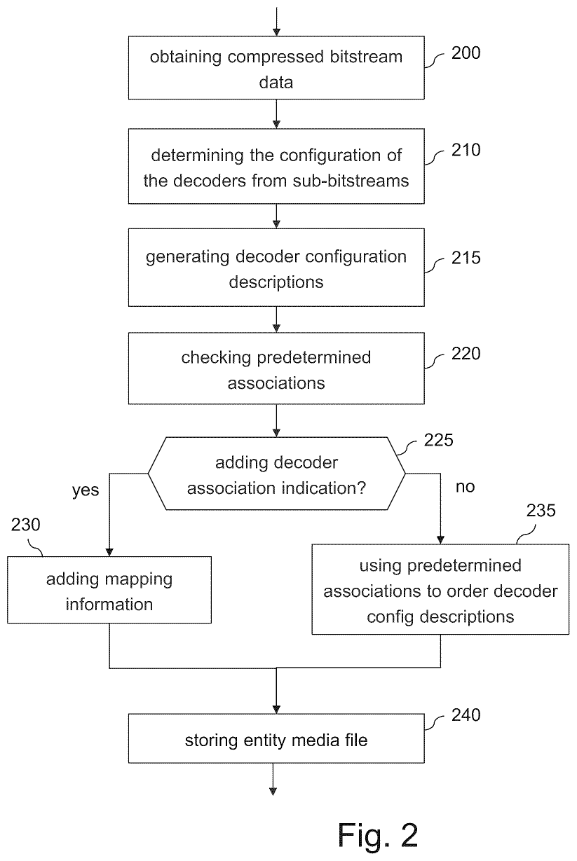

FIG. 2 illustrates an example of steps of an encapsulation process according to some embodiments of the disclosure. For the sake of illustration, the steps may be carried out in server 100 in FIG. 1, for example in encapsulation module 105.

As illustrated, a first step (step 200) is directed to obtaining compressed bitstream data to be encapsulated, for example by encapsulation module 105. The compressed bitstream data may be generated by compression module 140. In this case, the compression module to be used may be configured by a user through a graphical user interface or through a command line. Such a configuration may comprise setting the number of sample frames to encode, whether the different video sub-bitstreams use a single codec type and, if several video codecs are used, the set of video codecs and to which sub-bitstream each codec applies and also the dedicated codecs used for non-video sub-bitstreams.

For example, compressed bitstream data may be encoded according to the V3C sample stream format (Annex C of ISO/IEC 23090-5 specification or derived specifications). The V3C sample stream format defines V3C Units, each identified by a type (vuh_unit_type) defined in a V3C Unit Header field (also named v3c_unit_header). Each V3C unit contains one or more samples (or frames) corresponding to one sub-bitstream encoded data, the data being encoded using either a standard video codec (such as AVC (Advanced Video Coding), HEVC, VVC) or a dedicated codec. The dedicated codec may be identified by a specific four-character code registered by a registration authority (e.g., mp4 registration authority, also called “MP4RA”)).

Still for the sake of illustration, among the V3C units as specified in V-PCC, units with vuh_unit_type may be the following:
V3C_AD (for Atlas Data), that contains atlas data, giving information on how to reconstruct the 3D encoded data from the other V3C units present in the V3C bitstream. Atlas data are encoded using NAL (Network Abstraction Layer) unit format specified in 23090-5,
V3C_GVD (for Geometry Video Data), that contains geometry data, giving 3D position information. Geometry data may be encoded using any type of video codec,
V3C_AVD (for Attribute Video Data) that contains attribute data of a single attribute type information (for example Texture). The attribute data may be encoded using any type of video codec,
V3C_OVD (for Occupancy Video Data), that contains occupancy data, giving information on significant video area(s) described in geometry/attribute(s) sub-bitstreams. The occupancy data may be encoded using any type of video codec, and
V3C_PVD (for Packed Video Data), that, when present, contains packed data describing a set of geometry, attribute and occupancy encoded in different regions of a picture. The packed data may be encoded using any type of video codec.

Still for the sake of illustration, among the V3C units as specified in V-DMC, units with vuh_unit_type may be the following:
V3C_AD, that contains atlas encoded data as for V-PCC,
V3C_BMD (for base-mesh data), that contains base-mesh data, that gives information on a simplified mesh of the encoded 3D content. Base mesh data may be encoded using one of the coding scheme specified in ISO/IEC 23090-29, annex H or I. For example, Annex H describes a NAL unit-based sub-bitstream format for a base mesh.
V3C_GVD or V3C_ADD (for arithmetic coded displacement data), that contains data describing displacement information, applying to points described by the simplified base mesh. V3C_GVD data are encoded using any type of video codec. V3C_ADD data may be encoded using NAL (Network Abstraction Layer) unit format specified in ISO/IEC 23090-29, and
V3C_AVD (for Attribute Video Data), that contains attribute data of a single attribute type information (for example Texture). The attribute data may be encoded using any type of video codec.

Among the V3C units as specified in V3C, units with vuh_unit_type may be the V3C_VPS (for V3C parameters set) that is always present and provides parameters making it possible to identify how many different decoders are needed to process the V3C bitstream. It may also make it possible to identify the codec type of each sub-bitstream. These parameters include information of profile tier level (for example in a ptl_profile_codec_group_idc parameter) that enable identification of the codec type for a profile. For example for V-PCC, when the value coded with the last four bits of ptl_profile_codec_group_idc (also named PtlVideoCodecGroupIdc) is in the range [0 . . . 4], a single video codec is used for all V3C units containing video sub-bitstreams (i.e. all sub-bitstreams excepting the atlas sub-bitstream in V3C_AD V3C units). For example for V-DMC, when the value coded with the first three bits of ptl_profile_codec_group_idc (also named PtlNonVideoCodecGroupIdc) is in the range [0 . . . 1], it allows identifying codecs for base-mesh and/or displacement sub-bitstreams.

These parameters may also include the number of atlas sub-bitstreams (parameter vps_atlas_count_minus1) and the presence of V3C units containing sub-bitstreams, with one presence flag per V3C unit (parameters vps_occupancy_video_present_flag, vps_geometry_video_present_flag, vps_attribute_video_present_flag, vps_auxiliary_video_present_flag, and vpve_ac_displacement_present_flag) and vps_packed_video_present_flag additional parameters to determine the number of attributes (parameter ai_attribute_count) and geometry decoders per atlas (parameters vps_map_count_minus1 and vps_multiple_map_streams_present_flag).

Turning back to FIG. 2 and after having obtained the compressed bitstream data, the encapsulation module parses each sub-bitstream identified as present in the encoded data (step 210) to determine the decoder configuration of the sub-bitstream. According to some embodiments, this determination aims at identifying the codec type and the different parameters sets present in the sub-bitstream. For example, for a sub-bitstream that contains NAL units (for example using NAL sample stream format as per V3C specification or video coded sub-bitstream using NAL units such as HEVC, VVC or AVC as defined in ISO/IEC 14496-15), parameter set information retrieved from the corresponding sub-bitstream may correspond to a Sequence Parameter Set (SPS), a Frame Parameter Set (FPS) or a video Picture Parameter Set (PPS). According to some embodiments, the encapsulation module keeps in memory information identifying the sub-bitstream type, the codec type, the retrieved parameter sets of each sub-bitstream, and additional information that may be necessary for refinement of the step 220 as explained hereafter. For example, these items of information may be stored in an array denoted DecoderConfigurationsArray.

According to some embodiments, a DecoderConfigurationsArray is determined by identifying sub-bitstream delimiters (for example by identifying a V3C unit header if the bitstream is a V3C bitstream) in the first encoded data sample.

Then, populating the DecoderConfigurationsArray is performed by:
identifying the codec type either from the profile tier level information determined from the V3C Parameter Set (VPS) or from the settings of the encoder,
identifying the sub-bitstream to which the decoder configuration applies, and
obtaining the different parameters sets (specific to sub-bitstream) by parsing either all or part of the samples of the different sub-bitstreams.

Once populated, the DecoderConfigurationsArray makes it possible to determine an internal variable, for example denoted NumDecodes, indicating the number of sub-bitstreams present in the compressed bitstream data. If the bitstream is a V3C bitstream, NumDecodes corresponds to the number of different V3C unit headers (v3c_unit_header syntax) excluding the V3C Parameter Set. In a variant, the V3C Parameter Set may be considered provided if there is a corresponding decoder configuration.

In a variant, a number of decoders or a number of sub-bitstreams or NumDecodes is determined as a function of a number of sub-bitstream types, identifying the number of elements of the DecoderConfigurationsArray that corresponds to one particular sub-bitstream type.

In another embodiment, populating the DecoderConfigurationsArray is performed using items of information present in the V3C_VPS, even for determining the number NumDecodes of DecoderConfigurationsArray.

For example, considering a V3C bitstream (a V-PCC or a MIV bitstream as specified by the ptl_profile_toolset_idc) as specified in Annex A of ISO/IEC 23090-5, NumDecodes may be derived from V3C_VPS as follows (this may also apply to V-DMC and derived specifications from ISO/IEC 23090-5).

The number of sub-bitstreams (NumDecodes) is equal to the sum of the number of sub-bitstreams defined for each atlas provided in the V3C VPS. The VPS parameter vps_atlas_count_minus1+1 provides the number of atlases used in the V3C bitstream. For each atlas, the number of sub-bitstreams is determined as follows: first, the number of sub-bitstreams (NumDecodes) is initialized with the value zero. Then, the NumDecodes variable is incremented by one when one the following statement is true: when additional information is stored in a separate video stream (i.e. VPS's vps_auxiliary_video_present_flag[j] equals 1 for the atlas ID j) or when the atlas with atlas ID j have occupancy video data (i.e. vps_occupancy_video_present_flag[j] equals 1) or when the atlas with atlas ID j have packed video v data (i.e. vps_packed_video_present_flag[j] equals 1). Then, the number of sub-bitstreams is incremented by a value equal to the number of maps used for encoding the geometry (vps_map_count_minus1[j]+1 for the j-th atlas) when the atlas with atlas ID j have geometry video data (i.e. vps_geometry_video_present_flag equal 1). When the atlas have at least one or more attribute video data (i.e. vps_attribute_video_present_flag[j] equals 1), NumDecoders is incremented by the number of attribute signaled in the VPS (ai_attribute_count[j]) multiplied by the number of map (vps_map_count_minus1[j]).

```
NumDecodes = 0
for( k = 0; k <= vps_atlas_count_minus1; j++ ) {
  j = vps_atlas_id[ k ]
  NumDecodes += vps_auxiliary_video_present_flag[ j ]
  NumDecodes += vps_occupancy_video_present_flag[ j ]
  NumDecodes += vps_geometry_video_present_flag[ j ] *
(vps_map_count_minus1[ j ] + 1)
  if ( vps_attribute_video_present_flag[ j ] )
    NumDecodes += ai_attribute_count[ j ] * (
vps_map_count_minus1[ j ] + 1 )
  NumDecodes += vps_packed_video_present_flag[ j ]
}
```

Still for the sake of illustration, considering a V-DMC bitstream, NumDecodes may be derived from V3C_VPS as follows.

Compared to the V3C/V-PCC bitstream, the computation of the number of bitstreams includes an additional step when determining the number of sub-bitstreams for each atlas. The NumDecodes variable is incremented by 1 to count the basemesh sub-bitstreams and also by 1 when the atlas with atlas ID j have arithmetic coded displacement data (i.e. vpve_ac_displacement_present_flag[j] equals to 1).

```
NumDecodes = 0
for ( k = 0; k <= vps_atlas_count_minus1; j++ ) {
  j = vps_atlas_id[ k ]
  NumDecodes += vps_auxiliary_video_present_flag[ j ]
  NumDecodes += vps_occupancy_video_present_flag[ j ]
  NumDecodes += vps_geometry_video_present_flag[ j ] *
(vps_map_count_minus1[ j ] + 1)
  if ( vps_attribute_video_present_flag[ j ] )
    NumDecodes += ai_attribute_count[ j ] * (
vps_map_count_minus1[ j ] + 1 )
  NumDecodes += vps_packed_video_present_flag[ j ]
  NumDecodes += vpve_ac_displacement_present_flag[ j ]
  NumDecodes += 1 // For BaseMesh subbitstream.
}
```

Turning back to FIG. 2 and during the parsing of the sub-bitstreams identified as present in the encoded data, a configuration is determined or obtained for each of the decoders (still during step 210), i.e., for each of the NumDecodes decoders (for example one per sub-bitstream or one per sub-bitstream type).

Next, a description of each of the determined or obtained configurations is generated (step 215), at least one for each codec type, and for each of the generated descriptions, the sub-bitstream description(s), in the DecoderConfigurationsArray to which it applies is identified. Accordingly, if a bitstream comprises several sub-bitstreams, several descriptions of decoder configurations may be generated. However, since several sub-bitstreams may use the same codec type, it may occur that the same description of a decoder configuration is used for a set of several sub-bitstreams. In such a case, a single configuration description may be generated and associated with several decoders. This results in reducing the sample entry size of the corresponding ISOBMFF file (since the configuration descriptions may be stored in one or more sample entries, as described hereafter).

According to some embodiments, the descriptions of the decoder configurations are generated for all the sub-bitstreams by parsing the DecoderConfigurationsArray to populate an array, for example the array denoted DecoderDescriptionsArray, which stores the descriptions (or a decoder configuration record e.g., HEVCDecoderConfigurationRecord or VVCDecoderConfigurationRecord as per ISO/IEC 14496-15) of the decoder configurations and lists of indexes (e.g., lists denoted Cfg_Index_List), referencing the elements of the DecoderConfigurationsArray to which the descriptions apply.

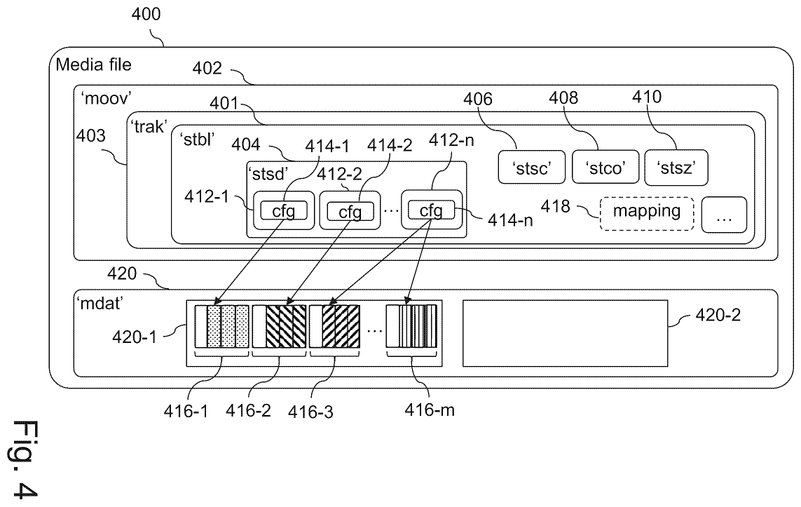

It is to be noted that at the beginning of step 215, the encapsulation module (e.g., encapsulation module 150 in FIG. 1) generates a metadata part of media file 135, comprising a box or a hierarchy of boxes to describe a single entity encapsulation, for example a single-track or a single-item encapsulation, as further described in reference to FIGS. 4, 5, 6 and 7.

After having generated a description of a decoder configuration from each input of the DecoderConfigurationsArray (i.e., for each sub-bitstream), a new element (description) is added into the DecoderDescriptionsArray only if there is no element in the DecoderDescriptionsArray with the same codec type and the same description of decoder configuration. When an element is added into the DecoderDescriptionsArray for the first time, a Cfg_Index_List associated with this element is created and a corresponding index within the DecoderConfigurationsArray is added to the Cfg_Index_List in order to establish a link between the description of the decoder configuration in the DecoderDescriptionsArray and the corresponding sub-bitstream in the DecoderConfigurationsArray.

If an element with the same codec type and the same description of the decoder configuration exists in the DecoderDescriptionsArray, the corresponding index in the DecoderConfigurationsArray is added to the Cfg_Index_List.

Therefore, at the end of step 215, a number (e.g., NumDecoderDescription) is determined, indicating the number of decoder descriptions provided in the encapsulation file. This NumDecoderDescription corresponds to the number of elements in the DecoderDescriptionsArray. It is smaller than NumDecodes (determined in step 210) if the same decoder description is used to configure several decoders.

According to other embodiments, the descriptions of the decoder configurations are generated per sub-bitstream type, by parsing the DecoderConfigurationsArray to populate an array, for example the array denoted DecoderDescriptionsArray, which stores the descriptions of the decoder configurations and lists of indexes (e.g., lists denoted Cfg_Index_List), referencing the elements of the DecoderConfigurationsArray to which the descriptions apply.

In such a case, at the end of step 215, a number of decoder descriptions (e.g., NumDecoderDescription) is determined per sub-bitstream type.

Next, a test is carried out to check predetermined rules (step 220), for example predetermined association rules. For the sake of illustration, step 220 may be directed to check whether predetermined association rules between the (NumDecodes) encapsulated sub-bitstreams and the (NumDecoderDescription) provided descriptions are unambiguous. This step aims at setting an internal flag (e.g., the internal flag denoted decoder_mapping_flag) to the false value if the association is unambiguous and to the true value if further information should be added in the description to have an unambiguous association. Still for the sake of illustration, the predetermined association rules may be a set of rules specifying how the descriptions of the decoder configurations are ordered in the metadata.

According to some embodiments, the predetermined association rules may require a one-to-one association between a decoder configuration and a sub-bitstream type. In such a case, if the NumDecoderDescription value is smaller than the Num Decodes value, the internal decoder_mapping_flag is set to the true value. The only case in which the decoder_mapping_flag is set to the false value is the case according to which the NumDecoderDescription value is equal to the NumDecodes value.

According to some other embodiments, the predetermined association rules may require the decoder configurations to appear in a specific sub-bitstream type order. It may also require that if several decoder configurations exist for a sub-bitstream type, they use the same order as specified in the VPS (through the different presence flags like vps_geometry_video_present_flag or vps_attribute_video_present_flag, etc.).

For example, the specific sub-bitstream type order may be [V3C_AD, V3C_GVD, V3C_AVD]. In the case according to which the compressed bitstream data are composed of the following sub-bitstreams: one V3C_AD described by a ‘v3cC’ codec configuration, one V3C_GVD described by a ‘hvcC’ codec configuration, and two V3C_AVD described by ‘hvcC’ codec configurations, the result of the check depends on the content of the descriptions of the decoder configurations in the DecoderDescriptionsArray for the ‘hvcC’ codec configuration.

If the DecoderDescriptionsArray contains one description of a decoder configuration for each V3C_AVD and for the V3C_GVD, the result of the check leads to setting the decoder_mapping_flag to the false value.

If the DecoderDescriptionsArray contains one description of a decoder configuration that applies to all V3C_AVDs and to the V3C_GVD, the result of the check leads to setting the decoder_mapping_flag to the true value in order to avoid repeating the same decoder configuration.

Next, it is determined whether an indication of the unambiguity of the association should be added in the metadata part of media file 135 (step 225).

According to some embodiments, the indication is provided by the presence of an additional parameter in the decoder configuration box of the compressed bitstream data. For example, when considering V-PCC or V-DMC, the V3CDecoderConfigurationRecord declared in the V3CConfigurationBox (‘v3cC’) may be modified to support new version as follow:

```
aligned(8) class V3CDecoderConfigurationRecord(unsigned int
version) {
  if(version == 0) {
    //as specified in 23090-10
    unsigned int(3) unit_size_precision_bytes_minus1;
    unsigned int(5) num_of_v3c_parameter_sets;
    // Unmodified section.
    ....
  } else if (version==1) {
    unsigned int(1) has_decoder_mapping_flag;
    unsigned int(3) unit_size_precision_bytes_minus1;
    unsigned int(5) num_of_v3c_parameter_sets;
    // Unmodified section.
    ...
    //optional
    if (has_decoder_mapping_flag) {
      // Additional mapping descriptions
    }
}
```

According to this example, the has_decoder_mapping_flag is set to 0 if the decoder_mapping_flag is set to the false value and the internal has_decoder_mapping_flag is set to 1 if the internal decoder_mapping_flag is set to the true value.

According to other embodiments, the indication of the unambiguity of the association is implicitly provided by the absence or presence of an additional box used to indicate mapping information, as the one added in step 230. This box, for example DecoderConfigToSubbitstreamMapBox or DecoderToSubbitstreamMapBox or DecoderConfigurationMappingBox, provides associations or mapping between decoder configuration information and sub-bitstreams to which a decoder configuration applies. The additional box is absent if the internal decoder_mapping_flag is set to the false value and the additional box is present if the internal decoder_mapping_flag is set to the true value. For the sake of illustration, it may be indicated as follows:

aligned(8) class DecoderToSubbitstreamMapBox extends Box(‘dssm’)
{
DecoderToSubbitstreamMappingRecord mapping;
}

In a variant, the DecoderToSubbitstreamMapBox enables to specify the mapping only for a subset of codec types, using following syntax:

```
aligned(8) class DecoderToSubbitstreamMapBox extends Box(‘dssm’)
{
  unsigned int(8) nb_codecs;
  for (i=0; i< nb_codecs; i++) {
    unsigned int(8) codec_type ;
    DecoderToSubbitstreamMappingRecord(codec_type);
  }
}
```

where
nb_codecs indicates the number of codecs for which a mapping to a decoder configuration is indicated and
codec_type takes a pre-defined value identifying a codec. It should be noted that codec type may also be specified using 32 bits, to store a 4cc indicating the type of codec.

The mapping parameter in the two above variants provides the mapping between a codec type, or a sub-bitstream type, and a decoder configuration. Some examples of DecoderToSubbitstreamMappingRecord syntax are described hereafter.

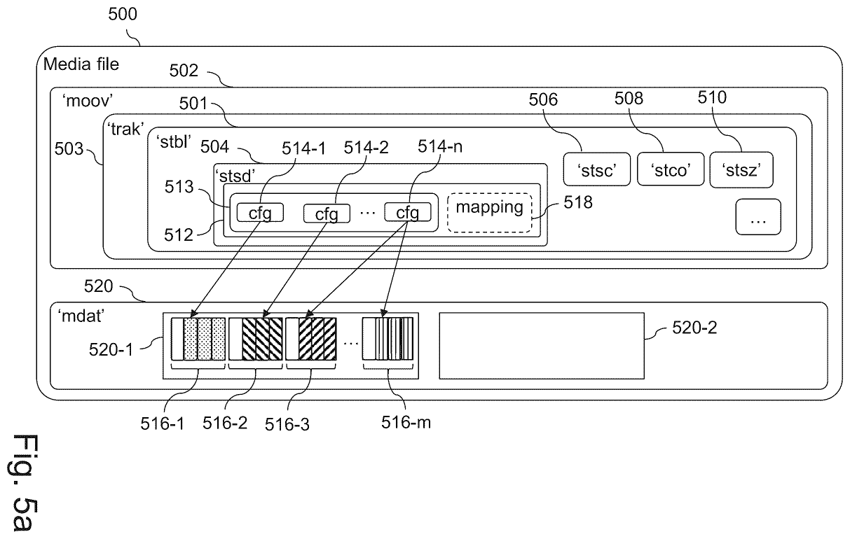

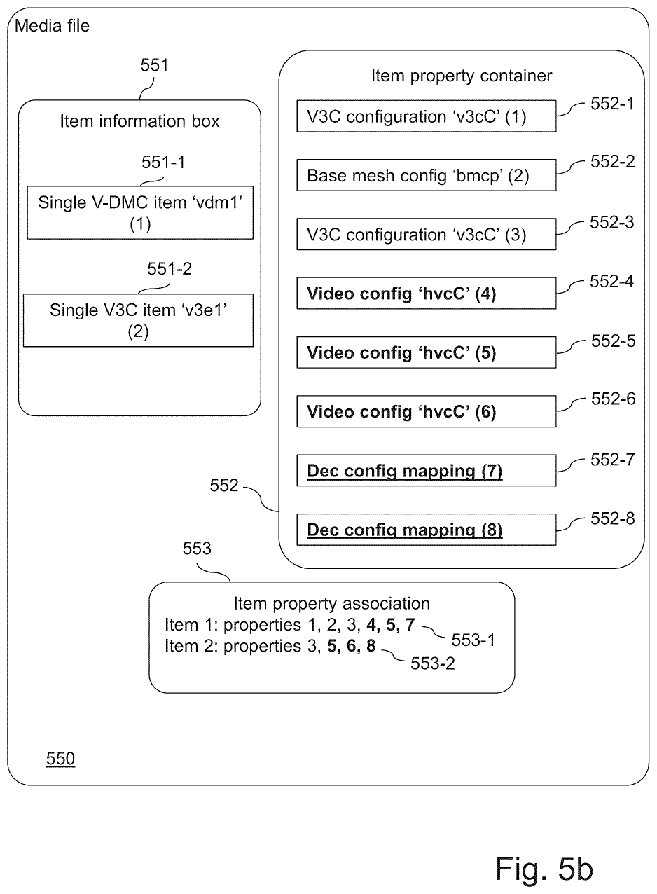

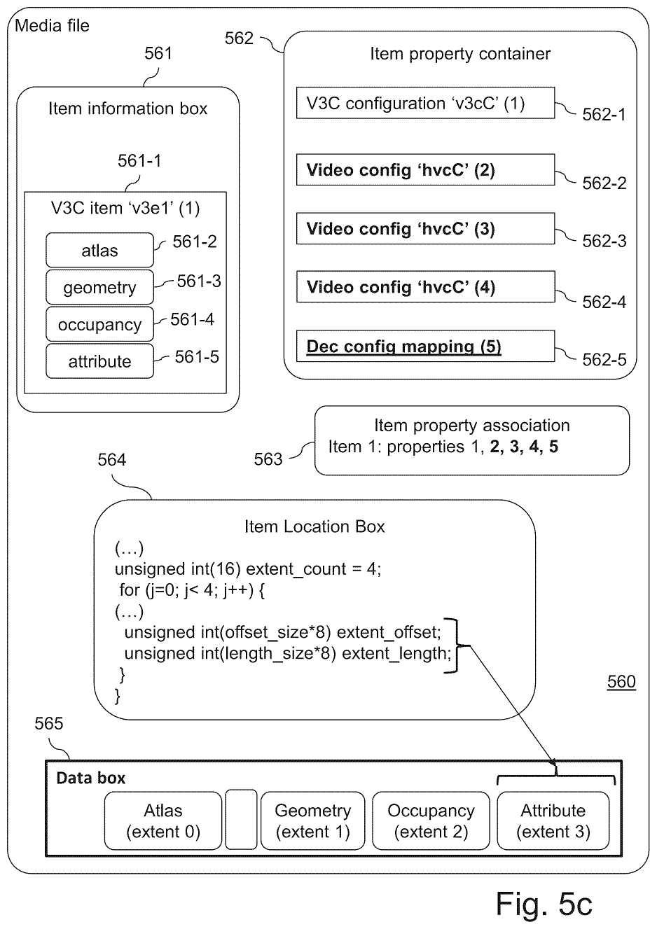

If the internal decoder_mapping_flag is set to the true value, a mapping description record information is added in the metadata part of media file 135 (step 230), describing the mapping association between the descriptions of the decoder configurations and the sub-bitstreams. This mapping description record is either defined in a specific box as the DecoderToSubbitstreamMapBox or as an additional syntax element of an existing box, for example in a V3CConfigurationBox, as described by reference to FIG. 5a.

According to some embodiments, the mapping association is specified per codec type and the mapping association description record information may be described as follows:

```
aligned(8) class DecoderToSubbitstreamMappingRecord(codec_type) {
  unsigned int(5) nb_associations;
  unsigned int(3) reserved;
  for (i=0; i < nb_associations; i++) {
    unsigned int(32) v3c_unit_header;
    unsigned int(8) decoder_cfg_index;
  }
}
```

where
codec_type is the codec type for which the association is described, nb_associations indicates the number of mapping associations indicated in the DecoderToSubbitstreamMappingRecord and
v3c_unit_header is the V3C unit header as per ISO/IEC 23090-5 of the V3C unit applying to the sub-bitstream that is mapped to a decoder configuration information and where decoder_cfg_index provides an index or identifier of a declared list of decoder configuration information for the V3C bitstream.

An alternative syntax for the DecoderConfigToSubbitstreamMapBox (or shorter name DecoderConfigurationMappingBox) may allow associating several sub-bitstreams with a decoder configuration, for example as follows (with a modification of the name):

```
aligned(8) class DecoderConfigToSubbitstreamMapBox extends
FullBox(‘dssm’, version=0, flags=0) {
  unsigned int(8) nb_associations;
  for (i=0; i < nb_associations; i++) {
    unsigned int(8) decoder_cfg_index;
    unsigned int(8) num_subbitstreams;
    for (j=0; j < num_subbitstreams; j++)
      unsigned int(32) v3c_unit_header;
  }
}
```

where nb_associations indicates the number of associations (or mappings) declared in this box, with the same semantics as above variant and where num_subbitstreams indicates the number of sub-bitstreams that use the decoder configurations specified by decoder_cfg_index.
decoder_cfg_index provides an index of a declared list of decoder configuration boxes for the V3C bitstream. It is a 1-based index with values between 1 to the number of configuration boxes declared in the containing sample entry minus 1 (since mandatory and common to all sub-bitstreams, the v3CConfigurationBox may not be mapped). When the V3CConfigurationBox is also mapped, decoder_cfg_index takes values between 1 and the number of configuration boxes declared in the containing sample entry. In a variant where only the video decoder configuration would be mapped (because other types are non ambiguous), the decoder_cfg_index takes values between 1 and the number of video configuration boxes declared in the containing sample entry.

This DecoderConfigToSubbitstreamMapBox or (shorter name DecoderConfigurationMappingBox) can be used in sample entries for V3C single track, for example a V3CBitstreamSampleEntry with sample entry type ‘v3e1’ or ‘v3eg’

```
aligned(8) class V3CBitstreamSampleEntry( )
  extends VolumetricVisualSampleEntry (′v3e1′ or ′v3eg′) {
  V3CConfigurationBox v3c_config;
  // zero or more configuration for video sub-bitstreams
  V3CVideoConfigurationBox video_config1(coding_type1=’avcC’);
  V3CVideoConfigurationBox video_config2(coding_type2=’hvcC’);
  DecoderConfigurationMappingBox mapping; //optional
  //additional boxes
}
```

It may be used in sample entries for V-DMC bitstreams, for example in V3CBitstreamSampleEntry with types ‘vdm1’ or ‘vdmg’:

aligned(8) class V3CBitstreamSampleEntry( )
extends VolumetricVisualSampleEntry (′vdm1′ or ′vdmg′) {

| | | |
|---|---|---|
| V3CConfigurationBox | v3c_config; | // ’v3cC’ |
| VDMCBaseMeshConfigurationBox | bmesh_config; | // ’vbmC’ |

| | |
|---|---|
| VDMCDisplacementConfigurationBox | displ_config; // |

```
optional ’vdcC’
    // zero or more configuration boxes for video sub-bitstreams
    V3CVideoConfigurationBox
video_config1(coding_type1=’hvcC’);
    V3CVideoConfigurationBox
video_config2(coding_type1=’hvcC’);
    DecoderConfigurationMappingBox mapping; //optional
    //additional boxes
}
```

The number of signaled decoder configurations in a V3CBistreamSampleEntry may be less than or equal to the number of V3C sub-bitstreams of the V3C bitstream. When it is less than the number of V3C sub-bitstreams, the DecoderConfigurationMappingBox (or DecoderConfigToSubbitstreamMapBox or mapping box) should be present to indicate which decoder configuration applies to which sub-bitstream(s). Whatever the sample entry type, there may be zero or more In the case according to which there DecoderConfigToSubbitstreamMapBox. would be multiple instances of DecoderConfigToSubbitstreamMapBox in a sample entry, the mapping should be consistent across these instances of the DecoderConfigurationMappingBox or mapping box. These instances may be complementary. Consistent means that no sub-bitstream should have several decoder configurations. Complementary means that, for example, a first mapping box (e.g. DecoderConfigurationMappingBox) describes associations for a first set of decoder configurations (or sub-bitstreams) and a second mapping box describes associations for a second set of decoder configurations (or sub-bitstreams). These complementary instances should be consistent. There may be multiple mapping boxes in sample entries in a SampleTableBox of a single track. This could be the case when the single track encapsulates several CVS (coded V3C sequence), each defining its own sample entry(ies) and thus possibly repeats or defines the mapping.

A V3CVideoConfiguration is defined as an abstraction of video decoder configuration boxes like for AVC, HEVC, VVC, or any other codec (MPEG or non-MPEG). The actual codec in use is identified by a 4CC, called for example codec_type (alternatively, it could be identified from the profile indication parameter from the V3C_VPS, like Pt/VideoCodecGroupIdc):

```
class V3CVideoConfigurationBox(codec_type) extends FullBox
(codec_type, version=0, 0) {
  switch (codec_type ) {
    case ’avcC’:
      AVCDecoderConfigurationRecord video_config;
      break;
    case ’hvcC’:
      HEVCDecoderConfigurationRecord video_config;
      break;
    case ’vvcC’:
      VVCDecoderConfigurationRecord video_config;
      break;
    default:
      break;
  }
}
```

with the following semantics:
video_config contains a decoder configuration record providing setup information for a video decoder of one or more sub-bitstreams of the V3C bitstream. The type of the video decoder configuration record is determined from the codec_type parameter. In the above syntax, only MPEG NAL-unit based codecs are considered, but the box can be extended to support more codec types, provided that they are registered in an authority (for example MP4 registration authority) and that they have an associated definition of the corresponding decoder configuration information. As an escape means for non-MPEG video codecs, or not registered ones, when a codec type is not recognized, or for V3C indicated by the component codec mapping SEI message, the above default case may provide an offset and size (not illustrated in the example syntax) into the data part of the file providing the decoder configuration information. When there is no such escape mechanism, either a parser raises an error (unrecognized or unsupported sub-bitstreams) or it implements a mechanism to obtain decoder configuration by other means than the track or sample description.

The mapping box in the V3C sample entries may be extended to also describe properties applying to sub-bitstreams, in addition to the decoder configuration information. For example, the sample entry may contain color information or HDR-related information per sub-bitstream (e.g. several instances of ‘clli’, ‘mdcv’ or ‘colr’ or any box providing properties for samples referencing this sample entry). In this case, these boxes may also be associated with sub-bitstreams. The payload of the mapping box further contains a 4CC for the box identification and an index giving the index of a box with the 4CC in the declaration order within the sample entry. The combination (4CC, index) is used to identify a box within the sample entry that is mapped to one or more sub-bitstreams.

The box for the decoder mapping may be declared as the last box of the sample entry. Alternatively, it may be declared anywhere in the list of boxes and only the boxes preceding this mapping box are associated with one or more sub-bitstreams. In another variant, when several mapping boxes are present, each mapping box maps the sub-bitstreams with the boxes (identified by a 4CC and an index) that precedes current map box. The mapping index of a box may be reset after each instance of mapping box present in the sample entry. In another variant, one mapping box may map a previous mapping box with one entry or box of the sample entry. In that case, the mapped box applied to all the sub-bitstreams mapped in the previous mapping box.

The mapping box enables associating the same video codec type to a set of different sub-bitstreams. In such a case, the decoder_cfg_index (i.e., the index of the description of the decoder configuration in the DecoderDescriptionsArray) are identical for all the sub-bitstreams of the set and the v3c_unit_header are different. This may occur, for example, for V-PCC, if the geometry and attribute sub-bitstreams use the same decoder configuration.

This also enables associating different video codec types to a set of sub-bitstreams. In such a case, the decoder_cfg_index are different and the v3c_unit_header may be the same. This may occur, for example, for V-PCC, when at least two (or any other number) attribute sub-bitstreams are encoded and are respectively assigned in the order of the table [hevc_cfg1, vvc_cfg1, hevc_cfg1, vvc_cfg1], where hvc_cfg1 and vvc_cfg1 are respectively single HEVC or VVC decoder configurations.

In a variant of this embodiment, the fields decoder_cfg_index and reserved may not be present, and the DecoderToSubbitstreamMappingRecord is specifying mapping for each codec_type.

According to other embodiments, the mapping association is specified per sub-bitstream type (or vuh_unit_type) and the mapping association description record information, may be described as follow:

```
aligned(8) class
DecoderToSubbitstreamMappingRecord(vuh_unit_type) {
  unsigned int(5) nb_associations;
  unsigned int(3) reserved;
  for (i=0; i < nb_associations; i++) {
    unsigned int(8) decoder_cfg_index;
  }
}
```

where vuh_unit_type is the sub-bitstream type for which the mapping is described, other parameters have same semantics as in previous example of DecoderToSubbitstreamMappingRecord.

This embodiment makes it possible to add mapping only for a subset of sub-bitstreams for which decoder configurations are ambiguous.

According to other embodiments, the mapping association is specified for all sub-bitstreams, referencing the position in sample entry box of the decoder configuration of each sub-bitstream. The mapping association description record information may be described as follows:

```
aligned(8) class DecoderToSubbitstreamMappingRecord( ) {
  unsigned int(8) num_decoders;
  for (i=0; i < num_decoders; i++) {
    unsigned int(32) v3c_unit_header;
    unsigned int(8) decoder_cfg_index;
  }
}
```

It should be noted that num_decoders may correspond to the number of all decoder configurations, as determined by sub-bitstream delimiters in step 210, It may also correspond to a subset of sub-bitstreams, as determined by NumDecodes calculation derived from V3C_VPS in step 210, which does not take into account the decoder configurations for atlas sub-bitstream.

This embodiment makes it possible to specify an association in any order, without any pre-determined order of the decoder configuration in the sample entry.

According to other embodiments, the mapping association is specified for all the sub-bitstreams or for a subset of sub-bitstreams by mapping a description of a V3C unit sub-bitstream to a four-character code identifying a configuration box (for example boxes like ‘avcC’, ‘hvcC’, ‘vvcC’, ‘vbmC’, ‘vdcC’, respectively for AVC, HEVC, VVC coded sub-bitstream and basemesh sub-bitstream and displacement sub-bitstream, this list being non limitative). When a sample entry contains more than one box of a given type, the mapping association may further indicate the number of the instance of the configuration box with this given type to avoid any ambiguity. This can be expressed as follows:

```
aligned(8) class DecoderToSubbitstreamMappingRecord( ) {
  unsigned int(8) num_sub_bitstreams;
  for (i=0; i < num_sub_bitstreams; i++) {
    unsigned int(32) v3c_unit_header;
    unsigned int(32) 4cc_config_box;
    unsigned int(8) 4cc_config_index;
  }
}
```

where
num_sub_bitstreams indicates the number of sub-bitstreams mapped into a decoder configuration box,
v3c_unit_header corresponds to the v3c_unit_header syntax element as defined in ISO/IEC 23090-5,
4cc_config_box is the four-character code indicating a type of configuration box and
the optional 4cc_config_index indicates the occurrence number of the configuration box with type equal to 4cc_config_box.

The mapping could also map a subset of sub-bitstreams based on their type (V3C unit type for example), or on the 4cc of configuration box to provide a lighter mapping, only where there may be some ambiguity. When parameterized by a 4CC, the mapping may not repeat the 4cc_config_box (becomes optional) and the 4cc_config_index becomes required.

According to the example described by reference to FIG. 2, this configuration requires that has_decoder_mapping_flag is set to 1 (the true value) in step 225.

Alternatively, if the internal decoder_mapping_flag is set to the false value, the pre-determined rules are applied to order the configuration descriptions of each sub-bitstream in the sample entry box of media file 135 (step 235).

Next, the metadata part and the media data part of media file 135 are finalized (step 240). It is to be noted that, instead of using a v3c_unit_header as an identifier of a sub-bitstream for the association between a decoder configuration and a sub-bitstream, a V3C unit header box (‘vunt’) may also be used to provide the sub-bitstream identification. Having a box may facilitate the parsing (possibility to identify and locate the information, skip the box when needed, etc.). It may be consistent for a mapping box used to associate decoder configuration but also properties to sample referencing a sample entry through a pair of box type (e.g. a 4CC) and box index (e.g. their declaration order in the parent box).

### Parsing Process

FIG. 3 illustrates an example of steps of a parsing process according to some embodiments of the disclosure, in order to decode the content of a media file, for example to decode the content of media file 135, by parser 120, and decompression module 150 in FIG. 1.

As illustrated, a first step is directed to receiving a media file (step 300), for example media file 135, or at least the portion of the media file comprising an initialization segment, making it possible for the parser to read and interpret metadata.

Next, the parser obtains the different decoder configuration boxes from the metadata (step 310), for example present in the SampleDescriptionBox (‘stsd’). It determines also, for example from V3C_VPS contained in a V3CConfigurationBox, the number of decoders to be instantiated by the decompression module (e.g., decompression module 150 in FIG. 1). This number may be determined from the V3C Parameter Set (i.e. the V3C unit with V3C_VPS unit type), similarly to the determination of the NumDecodes from V3C_VPS, as described with reference to FIG. 2.

Next, the parser determines whether a decoder description indication is provided (step 315) to determine how to associate the descriptions of the decoder configuration to the sub-bitstreams to decode. For the sake of illustration, it may set an internal AssociationMethod flag to a first value (e.g., 0) for pre-determined association (corresponding to step 325) or to a second value (e.g., 1) for a mapping association (corresponding to step 320).

According to some embodiments, determining whether a decoder description indication is provided comprises checking the status of the has_decoder_mapping_flag indication of the V3CDecoderConfigurationRecord (version=1), contained in the V3CConfigurationBox. If the flag is set to the first value, the association of the decoder configurations to each sub-bitstream is obtained from a pre-determined order of the decoder configuration(s) retrieved from the SampleDescriptionBox. Alternatively, if the flag is set to the second value, the association of the decoder configurations may be obtained from additional decoder information in the V3CConfigurationBox or from additional(s) DecoderToSubbitstreamMapBox(es). According to these embodiments, the AssociationMethod flag is set to the same value as the has_decoder_mapping_flag.

According to other embodiments, determining whether a decoder description indication is provided comprises checking the presence of a DecoderToSubbitstreamMappingRecord, either in the V3CDecoderConfigurationRecord (version=1) or in a DecoderToSubbitstreamMapBox. When any additional DecoderToSubbitstreamMapBox is present, the association of each of the sub-bitstreams with a decoder configuration is specified by DecoderToSubbitstreamMappingRecord. In these embodiments, the AssociationMethod variable is set to the first value (e.g., 0) if no additional information is present, and to a second value (e.g. 1) otherwise.

Next, after having determined whether a decoder description indication is provided, the association of the decoder configurations to each of the sub-bitstreams is performed, either following the pre-determined rules (step 325) or using the additional mapping information (step 320).

Next, each sub-bitstream decoder is initialized (step 330) to start processing the corresponding sub-bitstream it is configured to. The parser provides, for each of the sub-bitstream and according to the association determined in step 320 or 325, the decoder configuration to the decompression module 150. The decoding process of each sub-bitstream is then performed (step 335), by a decompression module, enabling the overall decoding of the compressed bitstream data. 3D content frame may then be reconstructed and possibly displayed, until the parser provides the last samples (frames) of each sub-bitstream.

Multiple Sample Entries, with Mapping Indicated as Independent Box in the Sample Table Box

FIG. 4 illustrates a first example of a media file 400, for example corresponding to media file 135 in FIG. 1, obtained after carrying out an encapsulation process according to some embodiments of the disclosure, for example the one described by reference to FIG. 2. FIG. 4 represents an ISOBMFF single-track description 400 of the carriage of timed visual volumetric video-based coded data.

As illustrated, the description of the timed visual volumetric video-based coded data comprises two main boxes: a metadata box 402 and a media data box 420. Metadata box 402 is a container of all the metadata boxes describing the encoded media data. More specifically, metadata box 402 is a MovieBox (‘moov’) describing a time sequence of volumetric video encoded data.

Media data box 420 is a MediaDataBox (‘mdat’) which contains the media data of the compressed bitstream data. According to this example, a sample of data (e.g., the sample 420-1 or 420-2) corresponds to a set of V3C units (for example m V3C units 416-1 to 416-m). Each of these V3C units corresponds to a sub-bitstream encoded with a specific decoder, and is composed of a V3C header (represented as a blank data part) and a set of NAL units (represented by textured part), representing one or several samples of the encoded sub-bitstream. A V3C header may contain a V3C unit length, in bytes, followed by a v3c_unit_header syntax element as defined in ISO/IEC 23090-5.

MovieBox 402 includes (among other boxes not represented) a TrackBox 403 (‘trak’) that carries temporal and spatial information, pertinent to decode, access and locate the media data samples stored in the MediaDataBox 420. More particularly, in the hierarchy of boxes contained in the TrackBox, SampleTableBox 401 (‘stbl’) is the one carrying the structures describing the samples. For the sake of illustration, SampleTableBox may comprise:
SampleToChunkBox (‘stsc’) 406 that contains information to find the chunk that contains a sample and its position,
ChunkOffsetBox (‘stco’) 408 or ChunkLargeOffsetBox (‘co64’) (alternative not represented) that contains information giving the index of each chunk into the containing file,
SampleSizeBox (‘stsz’) 410 that contains the number of samples composing the compressed bitstream data and a table giving the size in bytes of each sample, and
SampleDescriptionBox (‘stsd’) 404 that may contain several sample entries identifying the type of codec and parameters needed to initialize the codec.

For example, after encapsulating a V3C bitstream, using the steps described by reference to FIG. 2, sample entry 412-1 may contain a V3CBitstreamSampleEntry (‘v3e1’ or ‘v3eg’), including V3CConfigurationBox (‘v3cC’) 414-1, making it possible to initialize a decoder to decode part 416-1 of the sample, corresponding to an atlas sub-bitstream. Similarly, sample entry 412-2 may contain an HEVCSampleEntry (‘hvc1’ or ‘hve1’), including HEVCConfigurationBox (‘hvcC’) 414-2, making it possible to initialize a decoder to decode part 416-2 of the sample, corresponding to a geometry video sub-bitstream. Similarly also, sample entry 412-n may another contain HEVCSampleEntry (‘hvc1’), including different HEVCConfigurationBox (‘hvcC’) 414-n, making it possible to initialize two decoders (when m=4) to decode respectively each part 416-3 and 416-m of the sample, corresponding for example to two attribute video sub-bitstreams.

After encapsulating a V3C bitstream, for example using the steps described by reference to FIG. 2, an additional DecoderToSubbitstreamMapBox (‘dssm’), for example DecoderToSubbitstreamMapBox 418, may be present, for example as a result of carrying out step 225 in the FIG. 2.

If the association between decoder configurations (e.g., the decoder configuration stored in sample entries 412-1 to 412-n) and the sub-bitstreams to decode (e.g., the sub-bitstreams comprising the samples 416-1 to 416-m) is unambiguous using predetermined association rules, there is no need for an additional box used to indicate mapping information (e.g., step 235 in FIG. 2), for example box 418, that may be absent. Alternatively, if some of the associations or all the associations are ambiguous, an additional box used to indicate mapping information, for example box 418, is present to provide a DecoderToSubbitstreamMappingRecord making it possible to determine all the ambiguous associations or all the associations. This enables the decoder used for decoding all the sub-bitstreams to be correctly initialize.

In a variant, boxes 412-1, 412-2 to 412-n consist in the same sample entry, this sample entry containing multiple configuration boxes like 414-1, 414-2 to 414-n.

Multiple Decoder Configurations Described in a Single Sample Entry, with Mapping Indication and Descriptions Inside the Sample Entry

FIG. 5a illustrates a second example of a media file 500, for example corresponding to media file 135 in FIG. 1, obtained after carrying out an encapsulation process according to some embodiments of the disclosure, for example the one described by reference to FIG. 2, using a single-entry description in a SampleDescriptionBox (e.g., in SampleDescriptionBox 504). FIG. 5a represents an ISOBMFF single-track description 500 of the carriage of timed visual volumetric video-based coded data.

Like ISOBMFF single-track description 400 in FIG. 4, ISOBMFF single-track description 500 comprises two main boxes: a metadata box 502 and a media data box 520. Again, metadata box 502 is a container of all the metadata boxes describing the encoded media data. More specifically, metadata box 502 is a MovieBox (‘moov’) describing a time sequence of volumetric video encoded data.

Media data box 520 is a MediaDataBox (‘mdat’) which contains the media data of the compressed bitstream data. According to this example, a sample of data (e.g., the sample 520-1 or 520-2) corresponds to a set of V3C units (for example m V3C units 516-1 to 516-m). Each of these V3C units corresponds to a sub-bitstream encoded with a specific decoder, and is composed of a V3C header (represented as a blank data part) and a set of NAL units (represented by textured part), representing one or several samples of the encoded sub-bitstream.

MovieBox 502 includes (among other boxes not represented) a TrackBox 503 (‘trak’) that carries temporal and spatial information, pertinent to decode, access and locate the media data samples stored in the MediaDataBox 520. More particularly, in the hierarchy of boxes contained in the TrackBox, SampleTableBox 501 (‘stbl’) is the one carrying the structures describing the samples. For the sake of illustration, SampleTableBox may comprise:
SampleToChunkBox (‘stsc’) 506 that contains information to find the chunk that contains a sample and its position,
ChunkOffsetBox (‘stco’) 508 or ChunkLargeOffsetBox (‘co64’) (alternative not represented) that contains information giving the index of each chunk into the containing file,
SampleSizeBox (‘stsz’) 510 that contains the number of samples composing the compressed bitstream data and a table giving the size in bytes of each sample, and
SampleDescriptionBox (‘stsd’) 504 that may contain a single sample entry identifying the types of codec and parameters needed to initialize the codecs.

According to the illustrated example, SampleDescriptionBox (‘stsd’) 504 may contain a single sample entry 512 which is a V3CBitstreamSampleEntry, with possibly a new 4cc type, for example ‘v3f1’, or 4cc defined for single-track encapsulation such as ‘v3e1’ (or ‘v3eg’) for V3C or ‘vdm1’ (or ‘vdmg’) for V-DMC.

For example, after encapsulating a V3C bitstream, for example using the steps described by reference to FIG. 2, sample entry 512 may contain an V3CBitstreamSampleEntry (‘v3e1’), including a V3CConfigurationBox (‘v3cC’) 513, making it possible to initialize all the sub-bitstream decoders to decode all the parts (e.g., parts 516-1 to 516-m) of the samples. In other words, the sample description (e.g., ‘stbl’ or ‘stsd’ box) contains the exhaustive (or full) list of decoder configurations required to decode the V3C bitstream. Keeping a single configuration box to provide the exhaustive list of decoder configurations, possibly with their mapping to sub-bitstreams to which they apply, offers a generic and extensible solution, because it does not require to define a new configuration box when a new V3C unit is defined, for example to support a new codec or a new component (or sub-bitstream) type.

Still according to the illustrated example, a new V3CFullDecoderConfigurationRecord is contained in the V3CConfigurationBox. It may have the following syntax:

```
aligned(8) class V3CFullDecoderConfigurationRecord(unsigned int
version) {
  V3CDecoderConfigurationRecord(version=0) config; // P1
  unsigned int(1) has_decoder_mapping_flag; // start of P2
  unsigned int(5) nb_subbitstreams_configuration; // end of P2
  unsigned int(2) reserved; // start of P3
  for (int k=0; k < nb_subbitstreams_configuration; k++) {
      unsigned int(8) codec_type ;
      DecoderConfigurationRecord decoderCfg(codec_type);
  } // end of P3
  if (has_decoder_mapping_flag) { // start of P4
    DecoderToSubbitstreamMappingRecord mapping;
  } // end of P4
}
```

The description provided in V3CFullDecoderConfigurationRecord contains several information to associate a description of a decoder configuration to a sub-bitstream decoder.

For example, after having encapsulated a V3C bitstream, for example using the encapsulation process described by reference to FIG. 2, part P1 of the V3CFullDecoderConfigurationRecord (as indicated in the previous syntax, version=0) contains the description 514-1, making it possible to initialize a decoder to decode part 516-1 of the sample, corresponding to an atlas sub-bitstream.

Still according to the illustrated example, part P3 may describe a loop with the two following configurations (i.e., nb_subbitstreams_configuration=2):
one for a decoder configuration record identified by an HEVC codec type, for which the DecoderConfigurationRecord corresponds to HEVCDecoderConfigurationRecord 514-2, making it possible to initialize a decoder to decode part 516-2 of the sample, corresponding to a geometry video sub-bitstream and
one for a decoder configuration record identified by an HEVC codec type, for which the DecoderConfigurationRecord corresponds to HEVCDecoderConfigurationRecord 514-n (for example with n=3), making it possible to initialize two decoders (for example with m=4) to decode respectively each part 516-3 and 516-m of the sample, corresponding for example to two attribute video sub-bitstreams.

It is noted that DecoderConfigurationRecord(codec_type) corresponds here to already defined decoder configurations such as HEVCDecoderConfigurationRecord for HEVC codec type and VVCDecoderConfigurationRecord for VVC codec type among the defined video codecs in ISO/IEC 14496-15. It also extends to other types of codecs such as for example VDMCBaseMeshDecoderConfigurationRecord or VDMCDisplacementDecoderConfigurationRecord as specified in ISO/IEC 23090-10 for V-DMC.

Assuming that the encapsulation is carried out on the basis of the steps described in reference to FIG. 2 and that it is determined at step 225 that associations are ambiguous, the items of information provided by part P3 and P4 are all added corresponding to the mapping information 518, with has_decoder_mapping_flag=1.

For example, if the predetermined associations to check in step 220 require to declare the decoder configuration with a specific sub-bitstream order, such as [Atlas, Occupancy, Geometry, Attribute(s)] for V-PCC and such as [Atlas, Basemesh, Displacement, Attribute(s)] for V-DMC, with each configuration in the same order (requiring number of decoder configurations and number of decoder config descriptions to be the same) to be unambiguous, the following bitstreams are described as follow.

According to a first example, in the case of a V-PCC with one atlas with an v3c_cfg1, one occupancy with an hevc_cfg1, one geometry with a vvc_cfg1, and two attributes respectively in the order of the attributes (as declared in V3C_VPS) having an hevc_cfg2 and a vvc_cfg2, five decoder configurations (step 210) and five decoder configuration descriptions (step 215) exist. It results in an unambiguous decision in step 200, as a description (such as the V3CFullDecoderConfigurationRecord) respecting the predetermined rule for all the decoder configurations is possible. In that case, the V3CFullDecoderConfigurationRecord may be set as follow:
the decoder configuration for the atlas sub-bitstream is provided by V3CDecoderConfigurationRecord(0) (for v3c_cfg1),
has_decoder_mapping_flag is set to 0, signalling that no mapping is necessary,
nb_subbitstream_configuration is set to 4, for storing the decoder configuration descriptions of occupancy, geometry and attributes decoders,
the loop P3 (in the V3CFullDecoderConfigurationRecord format description here above) defines, in the following order:
   a codec_type signaling an HEVC codec for the occupancy, with a decoderCfg corresponding to an HEVCDecoderConfigurationRecord(for hevc_cfg1),
   a codec_type signaling a VVC codec for the geometry codec, with a decoderCfg corresponding to an VVCDecoderConfigurationRecord(for vvc_cfg1),
   a codec_type signaling an HEVC codec for the first attribute declared in V3C_VPS, with a decoderCfg corresponding to an HEVCDecoderConfigurationRecord(for hevc_cfg2), and
   a codec_type signaling a VVC codec for the second attribute declared in V3C_VPS, with a decoderCfg corresponding to a VVCDecoderConfigurationRecord(for vvc_cfg2), and
no mapping information P4 (in the V3CFullDecoderConfigurationRecord format description here above) is present.

It is to be noted that in that case, the codec type indication may be optional, as the order of decoder configuration is fixed, and then known for the predefined association.

According to a second example, in the case of a V-PCC with one atlas with an v3c_cfg1, one occupancy with an hevc_cfg1, one geometry with a vvc_cfg1, and two attributes respectively in the order of the attributes (as declared in V3C_VPS) having an hevc_cfg2 and a vvc_cfg1, five decoder configurations (step 210) and four decoder configuration descriptions (step 215) exist. It results in an ambiguous decision in step 220, as if respecting the predetermined rule, decoder configuration descriptions are repeated and therefore is inefficient, or only adding the available decoder configuration description does not enable determining which sub-bitstream (or decoder) a configuration applies to. In that case, the V3CFullDecoderConfigurationRecord may be set as follow:
the decoder configuration for the atlas sub-bitstream is provided by V3CDecoderConfigurationRecord(0) (for v3c_cfg1),
has_decoder_mapping_flag is set to 1, signalling that a mapping is provided,
nb_subbitstream_configuration is set to 3, for declaring the decoder config descriptions applying to occupancy, geometry and attributes decoders,
the loop P3 (in the V3CFullDecoderConfigurationRecord format description here above) defines, for example in the following order:
   a codec_type signaling an HEVC codec, with a decoderCfg corresponding to an HEVCDecoderConfigurationRecord(for hevc_cfg1),
   a codec_type signaling a VVC codec, with a decoderCfg corresponding to an VVCDecoderConfigurationRecord(for vvc_cfg1), and
   a codec_type signaling an HEVC codec, with a decoderCfg corresponding to an HEVCDecoderConfigurationRecord(for hevc_cfg2), and
mapping information P4 (in the V3CFullDecoderConfigurationRecord format description here above and using DecoderToSubbitstreamMappingRecord( ) is added as follow:
   NumDecodes is set to 4, to provide the mapping for the video decoders and
   the inner loop signals in any order the following decoder associations [(V3C_OVD, 0), (V3C_GVD, 1), (V3C_AVD #2, 1), (V3C_AVD #1, 2)], where the tuple corresponds to (v3c_unit_header, decoder_cfg_index).

It is noted that the content of v3c_unit_header, as specified, makes it possible to associate for attributes the configuration to the decoder it concerns, by providing an vuh_attribute_index information. In a variant, the decoder mapping description may contain additional fields to provide the correct association.

As another example, in the case of a V-DMC with one atlas with an v3c_cfg1, one Basemesh with bm_cfg1, one displacement with vvc_cfg1, and two attributes respectively in the order of the attributes (as declared in V3C_VPS) having vvc_cfg2 and wvc_cfg1, five decoder configurations (step 210) and four decoder configuration descriptions (step 215) exist. It results in an ambiguous decision in step 220, as if respecting the predetermined rule, the decoder configuration descriptions (here vvc_cfg1) is repeated and therefore is inefficient, or only adding the available decoder configuration description does not enable determining which sub-bitstream (or decoder) a configuration applies to. In that case, the V3CFullDecoderConfigurationRecord may be set as follow:
the decoder configuration for the atlas sub-bitstream is provided by V3CDecoderConfigurationRecord(0) (for v3c_cfg1),
has_decoder_mapping_flag is set to 1, signalling that a mapping is provided,
nb_subbitstream_configuration is set to 3, for declaring the decoder configuration descriptions applying to base-mesh, displacement and attributes decoders,
the loop P3 (in the V3CFullDecoderConfigurationRecord format description here above) defines, for example in the following order:
   a codec_type signaling an VVC codec, with a decoderCfg corresponding to an WCDecoderConfigurationRecord(for vvc_cfg1),
   a codec_type signaling a VVC codec, with a decoderCfg corresponding to an VVCDecoderConfigurationRecord(for vvc_cfg2), and
   a codec_type signaling a base-mesh codec, with a decoderCfg corresponding to an VDMCBaseMeshDecoderConfigurationRecord(for bm_cfg1), and
mapping information (using DecoderToSubbitstreamMappingRecord( )) is added as follow:
   NumDecodes is set to 4, to provide the mapping for the atlas and base-mesh decoders, and video decoders for displacement and attributes,
   the inner loop signals in any order the following decoder associations [(V3C_GVD, 0), (V3C_AVD #1, 1), (V3C_AVD #2, 0), (V3C_BMD, 2)], where the tuple corresponds to (v3c_unit_header, decoder_cfg_index).

According to some embodiments, the descriptions in the V3CConfigurationBox (‘v3cC’) 513, is using a V3CFullDecoderConfigurationPerTypeRecord, as follow:

```
aligned(8) class
V3CFullDecoderConfigurationPerTypeRecord(unsigned int version) {
  unsigned int(5) nb_subbitstreams_configuration;
  unsigned int(3) reserved;
  for (int k=0; k < nb_subbitstreams_configuration; k++) {
    unsigned int(1) has_decoder_mapping_flag;
    unsigned int(7) codec_type ;
    DecoderConfigurationRecord decoderCfg(codec_type);
    if (has_decoder_mapping_flag) {
      unsigned int(8) nb_associations;
      for (int j=0; j< nb_associations; j++)
        unsigned int(32) v3c_unit_header;
      }
    }
  }
}
```

This structure enables using mixing predetermined rules with mapping information. In that case, in FIG. 2, the steps 230 and 235 may be merged in a single step.

For example, the predetermined associations to check in step 220 may require declaring the decoder configuration with a specific sub-bitstream order, such as [Atlas, Occupancy, Geometry, Attribute(s)] for V-PCC and such as [Atlas, Basemesh, Displacement, Attribute(s)] for V-DMC, until the corresponding decoder configuration is unambiguous or is inefficient (as declaring the same decoder configuration multiple times).

According to a first example, in case of a V-PCC with one atlas with a v3c_cfg1, one occupancy with an hevc_cfg1, one geometry with a vvc_cfg1, and two attributes respectively in the order of the attributes (as declared in V3C_VPS) having an hevc_cfg2 and a vvc_cfg2, five decoder configurations (step 210) and five decoder config descriptions (step 215) exist. It results in an unambiguous decision in step 200, and the description V3CFullDecoderConfigurationPerTypeRecord respecting the predetermined rule is set as follow:
nb_subbitstream_configuration is set to 5, for storing the decoder configuration descriptions of occupancy, geometry and attributes decoders,
the loop defines, in the following order:
   a codec_type signaling an V3C codec for the atlas, with a decoderCfg corresponding to an V3CDecoderConfigurationRecord(0) (for v3c_cfg1). The has_decoder_mapping_flag is also set to 0, signalling that no mapping is necessary,
   a codec_type signaling an HEVC codec for the occupancy, with a decoderCfg corresponding to an HEVCDecoderConfigurationRecord(for hevc_cfg1). The has_decoder_mapping_flag is also set to 0, signalling that no mapping is necessary,
   a codec_type signaling a VVC codec for the geometry codec, with a decoderCfg corresponding to an VVCDecoderConfigurationRecord(for vvc_cfg1). The has_decoder_mapping_flag is also set to 0, signalling that no mapping is necessary,
   a codec_type signaling an HEVC codec for the first attribute declared in V3C_VPS, a with decoderCfg corresponding to an HEVCDecoderConfigurationRecord(for hevc_cfg2). The has_decoder_mapping_flag is also set to 0, signalling that no mapping is necessary, and
   a codec_type signaling a VVC codec for the second attribute declared in V3C_VPS, with a decoderCfg corresponding to a VVCDecoderConfigurationRecord(for wvc_cfg2). The has_decoder_mapping_flag is also set to 0, signalling that no mapping is necessary.

As a result, all decoder configurations are described in their order, without any mapping. The codec_type may be optional as the order of the configurations is known by the predetermined rule. It is to be noted that the determination of decoder configurations applying to each attribute is known by the declaration order respecting the one in the V3C_VPS and is then unambiguous.

According to another example, in the case of a V-PCC with one atlas, one occupancy with an hevc_cfg1, one geometry with a vvc_cfg1, and two attributes respectively in the order of the attributes (as declared in V3C_VPS) having an hevc_cfg2 and a vvc_cfg1, five decoder configurations (step 210) and four decoder config descriptions (step 215) exist. It results in an ambiguous decision in step 220, as if respecting the predetermined rule, decoder configuration descriptions are repeated and therefore is inefficient, or only adding the available decoder configuration description does not enable determining which sub-bitstream (or decoder) a configuration applies to. In particular, a mapping is necessary to apply the same vvc_cfg1 to both geometry and the second attribute. In that case, the V3CFullDecoderConfigurationRecord may be set as follow:
1 nb_subbitstream_configuration is set to 4, for declaring the decoder configuration descriptions applying to occupancy, geometry and attributes decoders,
the loop defines, in the following order:
   a codec_type signaling an V3C codec for the atlas, with a decoderCfg corresponding to an V3CDecoderConfigurationRecord(0) (for v3c_cfg1). The has_decoder_mapping_flag is also set to 0, signalling that no mapping is necessary,
   a codec_type signaling an HEVC codec, with a decoderCfg corresponding to an HEVCDecoderConfigurationRecord(for hevc_cfg1). The has_decoder_mapping_flag is also set to 0, signalling that no mapping is necessary,
   a codec_type signaling a VVC codec, with a decoderCfg corresponding to an VVCDecoderConfigurationRecord(for vvc_cfg1). The has_decoder_mapping_flag is now set to 1, signalling that mapping is necessary,
   Then a mapping information is added, for example as follow:
      nb_associations field is set to 2, to provide the mapping for the geometry and the second attribute to the vvc_cfg1 and.
      the inner loop signals in any order the following associations [V3C_GVD, V3C_AVD #2],
   a codec_type signaling a HEVC codec, with a decoderCfg corresponding to an HEVCDecoderConfigurationRecord(for hevc_cfg2). The has_decoder_mapping_flag is now set to 1, signalling that mapping is necessary, then a mapping information is added, for example as follow:
      nb_associations field is set to 1, to provide the mapping for the first attribute to the hevc_cfg2 and
      the inner loop signals the following association [V3C_AVD #1].

As a result, starting from the geometry, all the decoder configurations are using mapping to enable single decoder configuration descriptions and define clearly the associations with the sub-bitstream it applies to. It is to be noted that in that case, the first two elements of the loop are mandated to be the decoder configuration descriptions of the atlas sub-bitstream, followed by the one of occupancy sub-bitstream to respect the predetermined rule. For the other elements, the order is free as the mapping is provided. It is to be noted also that the determination of the decoder configurations applying to each attribute is known by the vuh_attribute_index present in the v3c_unit_header field.

In a variant of previous embodiments, the DecoderConfigurationRecord are preceded by an item of information directed to the decoder configuration size. This has advantage of enabling a reader to skip parsing a decoder configuration of an unknown (or not supported) codec_type.

According to another embodiment, the V3CFullDecoderConfiguration Record is defined as follow:

```
aligned(8) class V3CFullDecoderConfigurationRecord( ) {
  bool has_specific_codec = FALSE;
  V3CDecoderConfigurationRecord v3c_config;
  unsigned int(1) has_decoder_mapping;
  unsigned int(8) config_num;
  unsigned int(7) ptl_profile_codec_group_idc;
  unsigned int(8) ptl_profile_toolset_idc;
  PtlVideoCodecGroupIdc = ptl_profile_codec_group_idc & 0x0F;
  PtlNonVideoCodecGroupIdc = (ptl_profile_codec_group_idc&0x70)
  >> 4;
  for (int k=0; k < config_num; k++) {
    unsigned int(1) isVideoCodecGroup;
    if (has_decoder_mapping) {
      unsigned int(8) num_subbitstreams;
      for (i=0; i < num_subbitstreams; i++) {
        unsigned int(32) v3c_unit_header_4bytes;
      }
    }
    if (isVideoCodecGroup) {
      if (PtlVideoCodecGroupIdc != 15) {
        DecoderConfigurationRecord[PtlVideoCodecGroupIdc]
  decoderCfg;
      } else { // the codec type from CCM SEI
        has_specific_codec = TRUE;
      }
    }
    else if (PtlNonVideoCodecGroupIdc != 7) {
      DecoderConfigurationRecord[PtlNonVideoCodecGroupIdc,
  ptl_profile_toolset_idc, v3c_unit_header_4bytes] decoderCfg;
    } else { // the codec type from CCM SEI
      has_specific_codec = TRUE;
    }
  }
  if (has_specific_codec == TRUE) {
    unsigned int(8)[ ] ccm_sei_payload;
  }
  }
```

with the following semantics:
has_decoder_mapping equal to 1 indicates that the mapping of a decoder configuration record to its corresponding V3C sub-bitstream(s) is explicit and provided in the mapping decoder to sub-bitstream mapping record. When equal to 0, it indicates that the mapping of a decoder configuration to its corresponding V3C sub-bitstream(s) is implicit.
config_num indicates the number of decoder configuration records described in the V3CFullDecoderConfigurationRecord. The value of config_num may be less than the number of V3C sub-bitstreams when has_decoder_mapping equals to 1. Otherwise, when has_decoder_mapping equal to 0, config_num shall be equal to the number of V3C sub-bitstreams.
num_subbitstreams indicates the number of sub-bitstreams that use the decoder configurations specified by decoderCfg.
v3c_unit_header_4 bytes provides the first 4 bytes of the V3C unit containing the V3C sub-bitstream data to which the decoder configuration applies.
decoderCfg contains a decoder configuration record providing setup information for a decoder of one or more sub-bitstreams of the V3C bitstream. The decoder configuration record is determined from V3C specification and its extensions: for video coded sub-bitstreams, from the Table A-1 in Annex A.3 of ISO/IEC 23090-5; for non-video coded sub-bitstreams from Table A-3-“Available Non-Video CodecGroup profile components” in ISO/IEC 23090-5 or corresponding Tables in derived specifications (Part-29, for example). For video coded sub-bitstreams, the decoder config record is the one corresponding to the entry at index=PtlVideoCodecGroupIdc, according to the following mapping:

| | | DecoderConfigu- |
|---|---|---|
| PtlVideoCodecGroupIdc | 4CC code | rationRecord |
| 0 | ‘avc3’ | AVCDecoderConfigura- |
| | | tionRecord from ISO/IEC |
| | | 14496-15 |
| 1 | ‘hev1’ | HEVCDecoderConfigura- |
| | | tionRecord from ISO/IEC |
| | | 14496-15 |
| 2 | ‘hev1’ | HEVCDecoderConfigura- |
| | | tionRecord from ISO/IEC |
| | | 14496-15 |
| 3 | ‘vvi1’ | VVCDecoderConfigura- |
| | | tionRecord from ISO/IEC |
| | | 14496-15 |
| 4 | ‘hev1’ | HEVCDecoderConfigura- |
| | | tionRecord from ISO/IEC |
| | | 14496-15 |
| 5 . . . 14 | — | undefined |
| 15 | provided by | undefined |
| | external means | |
| | or may be | |
| | determined by | |
| | component | |
| | codec mapping | |
| | SEI message | |
| | (F.2.7) | |

For non-video coded sub-bitstreams, the decoder config record is the one corresponding to the entry at index=PtlNonVideoCodecGroupIdc in one of the V3C or V-DMC table, depending on the value of the ptl_profile_toolset_idc:

For ptl_profile_toolset_idc <128, it is undefined. For ptl_profile_toolset_idc >=128, the decoder config record is the one corresponding to the entry at index=PtlNonVideoCodecGroupIdc, according to the following mapping:

| Non-Video | PtlNonVid- | |
|---|---|---|
| CodecGroup | eoCodecGroupIdc | DecoderConfigurationRecord |
| BaseMesh | 0 | VDMCBaseMeshDecoderConfigu- |
| | | rationRecord from ISO/IEC 23090-10 |
| BaseMesh, | 1 | VDMCBaseMeshDecoderConfigu- |
| AC | | rationRecord from ISO/IEC 23090-10 |
| displacement | | (for v3c_unit_header_4bytes of type |
| | | V3C_BMD) |
| | | VDMCDisplacementDecoderConfigu- |
| | | ration Record from ISO/IEC 23090-10 |
| | | (for v3c_unit_header_4bytes of type |
| | | V3C_ADD) |
| Reserved | 2 . . . 6 | Undefined |
| MP4RA | 7 | Undefined |

ccm_sei_payload is the payload of the F.3.7 Component codec mapping SEI message semantics as defined in ISO/IEC 23090-5.

The use of this structure may require the following statements.

The V3C full decoder configuration record provides decoder configurations for all the V3C sub-bitstreams of a V3C bitstream. The number of signalled decoder configurations shall be less than or equal to the number of V3C sub-bitstreams of the V3C bitstream.

The number of decoder configurations may be less than the number of V3C sub-bitstreams when has_decoder_mapping equals to 1. It enables to signal a decoder configuration record that applies to several V3C sub-bitstreams.

The predetermined association rules may be also defined as follow.

When the number of decoder configuration records is equal to the number of V3C sub-bitstreams of the V3C bitstream, the has_decoder_mapping may be set to 0.

The implicit (or predetermined or predefined) declaration order for the decoder configuration records may be:
all non-video Codec decoders for basemesh (if any) in the order of the vuh_atlas_id,
followed by all non-video Codec decoders for arithmetic displacement (if any) in the order of the vuh_atlas_id,
followed by all video codec decoders for occupancy (if any) in the order of the vuh_atlas_id and vuh_map_index,
followed by all video codec decoders for geometry (if any) in the order of the vuh_atlas_id,
followed by all video codec decoders for attributes (if any) in the order of the vuh_atlas_id and vuh_attribute_index,
followed by all video codec decoders for packed video (if any) in the order of the vuh_atlas_id.

There may be alternative implicit declaration orders, for example by increasing value of V3C unit type indicating encoded data (e.g., as in Table 3 of ISO/IEC 23090-5: V3C_AD, V3C_OVD, V3C_GVD, V3C_AVD etc.). When several sub-bitstreams of a same V3C unit type occur, they may be further ordered according to an increasing index, like attribute index for video sub-bitstreams or as another example according to increasing atlas identifier when multiple atlases are present. Considering an implicit order based on the V3C unit types, this implicit order may be used for extensions of V3C, i.e. for future volumetric codecs considering other approaches than Point Cloud or meshes (e.g. coded representations for radiance fields or coded representations using Gaussian Splatting).

According to an embodiment, the V3CConfigurationBox is modified to consider V3CFullDecoderConfigurationRecord as follows:

```
class V3CConfigurationBox(version) extends FullBox(‘v3cC’,
version = 0 or 1, 0) {
    if (version == 0) {
      V3CDecoderConfigurationRecord v3c_config;
  }
    else if (version == 1) {
      V3CFullDecoderConfigurationRecord v3c_config;
  }
}
```

This has the advantage of enabling backward compatibility with V3C and multi-track support, by requiring for example that:
the value of version is equal to 0, except for single-track carriage with ‘vdm1’ or ‘vdmg’ sample entries where version=1 shall be used and
single-track carriage with ‘v3e1’ or ‘v3eg’ sample entries may use version=1.

The so-extended V3CConfigurationBox and the mapping between decoder configurations and sub-bitstreams may be applied to any specific codec deriving from V3C. These derivations may introduce new sub-bitstream types that can be represented by new V3C unit types. Likewise, codec types may be assigned and referred to in profiles with corresponding configuration information. These new definitions can then be used in the variants of the mapping described above to provide full (or exhaustive) decoder configuration information to decode the V3C derived bitstream. This could apply to volumetric representations using other representations than point clouds or meshes like for example radiance fields or gaussian splatting.

In a variant, in place of using version to select the decoder configuration record (the “full” version or not), the flags field of the V3C configuration full box may be used for the same purpose.

In another variant, the definition of V3CDecoderConfigurationRecord is extended with a new version providing all the required decoder configuration records, with their mapping to sub-bitstream(s), as follows:

```
aligned(8) class V3CDecoderConfigurationRecord(unsigned int
version) {
  if(version == 0 || version == 1){
    unsigned int(3) unit_size_precision_bytes_minus1;
    unsigned int(5) num_of_v3c_parameter_sets;
    for (int i=0; i < num_of_v3c_parameter_sets; i++) {
        unsigned int(16) v3c_parameter_set_length;
        bit(8) v3c_parameter_set[v3c_parameter_set_length];
    }
    unsigned int(8) num_of_setup_unit_arrays;
    for (int j=0; j < num_of_setup_unit_arrays; j++) {
        unsigned int(1) array_completeness;
        bit(1) reserved = 0;
        unsigned int(6) nal_unit_type;
        unsigned int(8) num_nal_units;
        for (int i=0; i < num_nal_units; i++) {
            unsigned int(16) setup_unit_length;
            bit(8) setup_unit[setup_unit_length];
        }
    }
  }
  if(version == 1){ // exhaustive list of decoder config record
with mapping
    unsigned int(7) additional_config_num;
    unsigned int(1) has_decoder_mapping;
      for (int k=0; k < additional_config_num; k++) {
          unsigned int(1) isVideoCodecGroup;
          unsigned int(5) vuh_unit_type; // the value to navigate
in Tables below; coming from the V3C unit containing one of the
xPS stored in the dec Config.
          unsigned int(2) reserved;
        if (isVideoCodecGroup) {
          if (PtlVideoCodecGroupIdc != 15) {
            DecoderConfigurationRecord[PtlVideoCodecGroupIdc]
decoderCfg;
          }
        }
        else {
          if (PtlNonVideoCodecGroupIdc != 7) {
DecoderConfigurationRecord[PtlNonVideoCodecGroupIdc,
ptl_profile_toolset_idc, vuh_unit_type] decoderCfg; // or V3C
unit type
          }
        }
          if (has_decoder_mapping) {
            unsigned int(8) num_subbitstreams;
            for (i=0; i < num_subbitstreams; i++) {
              unsigned int(32) v3c_unit_header_4bytes;
            }
          }
  }
}
```

with the following semantics:
additional_config_num indicates the number of decoder configuration records for sub-bitstreams described in the V3CDecoderConfigurationRecord, except the one for the atlas sub-bitstream. The value of additional_config_num may be less than the number of V3C sub-bitstreams when has_decoder_mapping is equal to 1. Otherwise, when has_decoder_mapping is equal to 0, additional_config_num should be equal to the number of V3C sub-bitstreams,
has_decoder_mapping provides information related to the mapping: when it is equal to 1, it indicates that the mapping of a decoder configuration record to its corresponding V3C sub-bitstream(s) is explicit and is provided in the loop of additional configuration records for sub-bitstreams and when it is equal to 0, it indicates that the mapping of a decoder configuration is not specified, num_subbitstreams indicates the number of sub-bitstreams that use the decoder configurations specified by decoderCfg,
v3c_unit_header_4 bytes provides the first 4 bytes of the V3C unit containing the V3C sub-bitstream data to which the decoder configuration record applies. In a variant, instead of the 32 bytes, a box may be preferred, for example a V3C unit header box (‘vunt’). While it requires more byte of description, it can be located in the metadata part of the file and the box size allows skipping it if parser does not need it (e.g. a sub-bitstream is not processed for example).
   decoderCfg contains a decoder configuration record providing setup information for a decoder of one or more sub-bitstreams of the V3C bitstream. The decoder configuration record is determined from V3C specification and its extensions: for video coded sub-bitstreams, from the Table A-1 in Annex A.3 of ISO/IEC 23090-5 (as explained in the previous variant); for non-video coded sub-bitstreams from Table A-3-“Available Non-Video CodecGroup profile components” in ISO/IEC 23090-5 or corresponding Tables in derived specifications (ISO/IEC 23090-29, for example).

For non-video coded sub-bitstreams, the decoder config record is the one corresponding to the entry at the PtlNonVideoCodecGroupIdc index in one of the V3C or V-DMC table, depending on the value of the ptl_profile_toolset_idc (as explained in the previous variant), except the use of Table A-3 that would consider the vuh_unit_type instead of a v3c_unit_header:

| Non-Video | PtlNonVid- | |
|---|---|---|
| CodecGroup | eoCodecGroupIdc | DecoderConfigurationRecord |
| BaseMesh | 0 | VDMCBaseMeshDecoderConfigu- |
| | | rationRecord from ISO/IEC 23090-10 |
| BaseMesh, | 1 | VDMCBaseMeshDecoderConfigu- |
| AC | | rationRecord from ISO/IEC 23090-10 |
| displacement | | (for vuh_unit_type = V3C_BMD) |
| | | VDMCDisplacementDecoderConfigu- |
| | | ration Record from ISO/IEC 23090-10 |
| | | (for vuh_unit_type = V3C_ADD) |
| Reserved | 2 . . . 6 | Undefined |
| MP4RA | 7 | Undefined |

In this variant, the parameters set for the atlas are kept in an initial loop (i.e., the one after the statement if (version==0∥version==1)). But in another variant, for the new version of the box, the atlas decoder configuration is also in the loop on “additional_config_num”, to keep a clear separation between the existing version 0 of the V3CDecoderConfigurationRecord and the new version according to embodiments of this invention.

In yet another embodiment, the V3C bitstream comprises one image or a sequence of images that do not require timed processing. In that case, the media file generated for the encapsulation may generate one or more image items or a sequence of image items. As a result, the metadata describing the configuration of the V3C bitstream and sub-bitstreams is described in ‘meta’ box. The encapsulation processing performed for items or sequences of images is similar to the embodiments described with reference to FIG. 2. A difference is that the decoder configurations determined in step 220 and their association with the V3C sub-bitstreams determined in steps 220, 225, 230 and 235 are described as an item property within the item property container (e.g. ‘ipco’ box). Step 240 is modified so that the generated media file encapsulates the V3C bitstream in one or more items with decoder configuration (e.g. V3CFullDecoderConfigurationRecord structure) and the mapping (e.g. DecoderToSubbitstreamMappingRecord structure) are stored in an item property. The ItemPropertyAssociationBox box (‘ipma”) associates the item and the decoder configurations described in the item property container.

The parsing of the media file when the media comprises one or more items associated with an Item property describing V3C sub-bitstreams and mapping information (e.g., a V3CFullDecoderConfigurationRecord structure) is similar to the one described in the previous embodiments with reference to FIG. 3. Step 300 is modified to parse the items and the items properties associated with items. In step 310, the decoder configuration is obtained from the item property associated with the item. The remaining processing steps are similar to the one described for V3C bitstreams encapsulation in tracks.

FIG. 5b illustrates how the decoder mapping may apply to single V3C items. Media file 550 may represent a static volumetric file with two items declared in item information box 551, for example the ‘iinf’ box in ISOBMFF. These items can have properties associated with. The properties may be declared in property container box 552, for example the ‘ipco’ box in ISOBMFF, and the association may be described in box 553, for example the ‘ipma’ box in ISOBMFF. According to the illustrated example, box 551 declares two 3D items 551-1 and 551-2, respectively a V-DMC item and a V-PCC item, for example as ‘infe’ boxes in ISOBMFF. While the standard ISO/IEC 23090-10 specifies V3C items as being associated with a V3C configuration property 552-1 and with a BaseMeshConfigurationProperty 552-2 for single V-DMC items, it remains silent on the video configuration properties. For example, a V-PCC item may contain a video-coded sub-bitstream representing occupancy information and another video-coded sub-bitstream representing a texture attribute. As another example, a V-DMC item may contain a video-coded sub-bitstream representing the displacement information and another video-coded sub-bitstream representing a texture attribute. To determine whether a player can decode and render these items, it may be convenient to expose the required configuration for the video decoders. It is thus proposed to use an exhaustive description of the configuration properties in property container box 552. Moreover, to correctly initialize a decoder for a given sub-bitstream, a decoder mapping information may also be declared (e.g. 552-7 and 552-8) as a property and associated with the 3D items as shown with item property association 553-1 and 553-2.

It is to be noted that not all the boxes contained in the media file 550 are described here, for the sake of clarity.

To be able to use Decoder configuration mapping structure for tracks and for items, it is proposed to define Decoder configuration mapping structure. The DecoderConfigurationMappingStructure provides associations or mapping between decoder configuration information and sub-bitstreams to which a decoder configuration applies. Its syntax can be described as follows:

```
aligned(8) class DecoderConfigurationMappingStructure {
    unsigned int(8) nb_associations;
    for (i=0; i < nb_associations; i++) {
      unsigned int(8) decoder_cfg_index;
      unsigned int(8) num_subbitstreams;
      for (j=0; j < num_subbitstreams; j++)
        unsigned int(32) v3c_unit_header;
  }
}
```

with the following semantics:
nb_associations indicates the number of associations declared in this structure,
decoder_cfg_index provides an index in a list of declared decoder configuration boxes. For tracks, the list is declared in a sample entry and the index is a 1-based index with values between 1 and the number of configuration boxes declared in the containing sample entry. For items, the list is declared in ItemPropertyContainerBox and the index is a 1-based index with values between 1 and the number of properties declared in ItemPropertyContainerBox. In a variant where only the video decoder configuration would be mapped (because other types are non ambiguous), the decoder_cfg_index takes values between 1 to the number of video configuration boxes declared in the containing sample entry or in ItemPropertyContainerBox.
num_subbitstreams indicates the number of sub-bitstreams that use the decoder configuration specified by the decoder_cfg_index, and
v3c_unit_header is the V3C unit header as per ISO/IEC 23090-5 or derived specifications of the V3C unit applying to the sub-bitstream that is mapped to a decoder configuration information.

In a variant, the decoder_cfg_index may refer to an index of property association in ItemPropertyAssociationBox for the V3C item. This enables the content of the ItemPropertyContainerBox to change in case of file editing. There is no change in the order of properties associated with the V3C item in ItemPropertyAssociationBox and only the values of indexes in the ItemPropertyAssociationBox needs to be updated. According to this variant the semantics of decoder_cfg_index may be defined as follows:
decoder_cfg_index provides, when declared in a sample entry of a track, an index of a declared list of decoder configuration boxes in the sample entry, or, when declared for an item, an index of a property association in ItemPropertyAssociationBox for the associated item. It is a 1-based index with values between 1 and the number of configuration boxes or properties declared in the containing sample entry or associated to an item respectively.

For a V3C track or V3C item, the V3CConfigurationBox or property may not be mapped, because it is required and common to all the sub-bitstreams.

It is also proposed to create a new Decoder configuration mapping item property, with the following definition:
Box Types: ‘dssm’
Property type: Descriptive item property
Container: ItemPropertyContainerBox
Mandatory (per item): No
Quantity (per item): Zero or one

The Decoder configuration mapping item property provides associations or mapping between decoder configuration information and sub-bitstreams to which a decoder configuration applies.

The Decoder configuration mapping item property is an essential property since it is required to initialize the video decoders. The corresponding essential flag in the ItemProperyAssociationBox shall be set to 1 for a ‘dssm’ item property.

Its syntax may be the following one:

aligned(8) class DecoderConfigurationMappingProperty extends
ItemProperty(‘dssm’, version=0, flags) {
DecoderConfigurationMappingStructure config_mapping;
}

with the following semantics:
config_mapping contains a single instance of DecoderConfigurationMappingStructure which is defined above.

This property may be referenced in the Table referencing the box types specified by ISO/IEC 23090-10 by adding the following under definition of ‘vire’ in ‘ipco’:

| | |
|---|---|
| 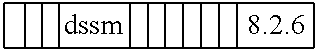 | Decoder configuration mapping item property |

Following the definition of a common structure for tracks and items, the decoder configuration mapping box can be updated as follows:

aligned(8) class DecoderConfigurationMappingBox extends
FullBox('dssm’, version=0, flags=0) {
DecoderConfigurationMappingStructure config_mapping;
}

with the following semantics:
config_mapping contains a single instance of DecoderConfigurationMappingStructure as defined above.

Then, when used for non-timed V-PCC Item, for non-timed MIV Item or for non-timed V-DMC Item, an item of type ‘vxx1’ (‘v3e1’ or ‘vdm1’) should have at least one video decoder configuration property applying to one or more video sub-bitstreams contained by the item. When only one video decoder configuration property is present, it makes it possible to initialize decoder for all video sub-bitstreams and a DecoderConfigurationMappingProperty may not be present. Otherwise, when more than one video decoder configuration property is present for a 3D item, a DecoderConfigurationMappingProperty is present, for example in the item property container box 552.

In a variant, when a plurality of item properties comprising decoder configuration information, for instance for video-based decoder configuration information, is associated with a V3C item, and each of these item properties have a different box or property type, this may be an indication that the decoder configuration information are associated with each sub-bitstream in a predetermined order, for instance, a sub-bitstream is associated with its associated item properties comprising decoder configuration information in the order of declaration of property association in the ItemPropertyAssociationBox and therefore no DecoderConfigurationMappingProperty needs to be defined. When multiple item properties comprising decoder configuration information are associated with a V3C item and some of them have the same box or property type, for instance for video-based decoder configuration information, this may be an indication that a DecoderConfigurationMappingProperty may be present to associate the decoder configuration information with the sub-bitstreams. When there is one decoder configuration property per sub-bitstream, there may be no ambiguity as soon as the decoder configuration properties are declared in the same order in the item property container box, or, in a variant, in the property association box, as the sub-bitstreams in the SPS of the V3C item, in particular for the video sub-bitstreams. When there is no ambiguity, the decoder configuration mapping box may be omitted in the list of properties associated to the V3C item. This is also the case when there is only one video decoder configuration mapping property: this should apply to all video sub-bitstreams of the V3C item and mapping is optional.

There may be variants for the decoder mapping structure for items, especially when they use a specific construct as depicted in FIG. 5c.

Like FIG. 5b, FIG. 5c illustrates how the decoder mapping may apply to single V3C items. As illustrated, a V3C single item 561-1 (whatever the inner coding type, e.g., V-PCC, MIV, V-DMC or other), containing several sub-bitstreams (561-2 to 561-5), is stored in a media file 560 compliant with ISOBMFF as one extent per sub-bitstream, as shown in the data box 565. According to this example, the storage of V3C items uses ItemLocationBox 564 to easily find the data for a given sub-bitstream. Indeed, the extent offset and length provided in the ItemLocationBox make it possible to describe the byte ranges in the data part of the media file. These byte ranges do not need to be contiguous. When such construction is in use, the decoder mapping information may, instead of using the v3c_unit_header use an extent_index. For example, video configuration 562-2 encoding the geometry sub-bitstream can be mapped to extent 1 corresponding to the data of this geometry sub-bitstream. Likewise, video configuration property 562-3 and 562-4 can be mapped to extents 2 and 3 respectively. It is observed that the order of data sub-bitstreams in data box 565 does not need to match the property declaration order in 562.

Such V3C item storage may avoid the use of the ‘subs’ property to access to sub-bitstream byte ranges. Moreover, it could allow direct storage of NAL units in the extents instead of V3C units, thus facilitating the extraction and sending of each sub-bitstream to appropriate sub-bitstream decoders. For interoperability, an implicit order may be specified in ISO/IEC 23090-10 so that extent index by default matches a sub-bitstream type (or V3C unit type). For example, the first extent for a V3C item contains the atlas sub-bitstream, the second contains the geometry, followed by occupancy and by each attribute in increasing number of their attribute index. However, since some sub-bitstreams are optional, another possibility is to describe the extent order, for example as another item property associated with a V3C item. This property may also provide, in addition to the sub-bitstream type, the corresponding decoder configuration either inline or in a variant as a property index in the property declaration box 562. In the latter case, this property could replace the decoder configuration mapping property 562-5. A syntax for this property can be defined as follows:
Box type: ‘3dex’
Property type: Descriptive item property
Container: Item PropertyContainerBox
Mandatory (per item): No
Quantity (per item): At most one

The 3D Constrained Extents Property descriptive item property indicates that each extent of the associated item in the itemLocationBox is constrained to enclose data units of the same sub-bitstream type. For example, for a V3C or G-PCC item, the sub-bitstream type may be a unique V3C unit type or G-PCC unit type, respectively. For an attribute type, the attribute index should also be indicated to unambiguously identify each sub-bitstream. Each sub-bitstream is then extractable as a contiguous byte range and is independently decodable and renderable, as for example a mesh only or a mesh plus a texture for a V-DMC item. As another example, a 3D Gaussian Splat item with only the DC component of its spherical harmonics may be extractable as a contiguous byte range and may be independently decodable and renderable. This property may be important when a 3D item is stored as one extent per sub-bitstream. The presence of this property associated with an item informs a player that data are organized in a specific way. When not present, there may be no indication of byte ranges per sub-bitstream, unless a subs property is present.

The configuration data needed to decode each extent independently may be present within the 3D Constrained Extents Property. In a variant, the configuration data are indicated as an index of a decoder configuration property index in the property container box.

The flags field may be used to signal the presence of sub-bitstream decoder configuration related information. The following flags values may be defined. 0x000001 inline_decoder_config: when it is set to a first value, for example 1, it specifies that the decoder configurations for the sub-bitstreams are contained in the property. When not set to this value, they are indicated as a property index. It is noted that this flag may be optional if the 3D constrained extent property is defined according to only one variant among containing references to decoder configuration properties or containing the decoder configuration property. Preferably the first variant is chosen to allow mutualization of some decoder configurations and to keep on associating the v3cC configuration property to the V3C item, or more generally mandatory property to be associated to a 3D item that could also apply to a sub-bitstream of this 3D item.

An example of syntax may be the following:

```
aligned(8) class 3DConstrainedExtentsProperty
extends ItemFullProperty(‘3dex’, version = 0, flags) {
  unsigned int(16) entry_count;
  for (i=0; i< entry_count; i++) {
    unsigned int(32) extent_type;
    if (extent_type = attribute_type)
        unsigned int(32) attribute_idx;
    if (flags & inline_decoder_config) {
      unsigned int(32) extent_config_length;
      DecoderConfigurationRecord( ) extent_config;
    } else {
      unsigned int (16) config_property_index;
    }
  }
}
```

with the following semantics:
entry_count, that specifies the number of entries in the property. It corresponds to the number of extents for the associated 3D item,
extent_type, that specifies the type of data of the sub-bitstream carried in an extent. For V3C, it should correspond to a V3C unit type. For G-PCC, it should correspond to a G-PCC unit type. In a variant it may correspond to a NAL unit type if the extents directly store the NAL units and not the V3C or G-PCC unit or any additional abstraction layer on top of the NAL unit,
attribute_idx, that specifies an index of a sub-bitstream representing an attribute, in short an attribute sub-bitstream index. Its value should match one of the attribute index declared in a SPS or VPS when present,
extent_config_length that is the length in bytes of the decoder configuration record for the extent. When set to 0, it means that the extent is not mapped to any decoder configuration, because there may be no ambiguity for the sub-bitstream type corresponding to this extent. This may be the case, for example, for a base mesh sub-bitstream for V-DMC item, or for an extent corresponding to an atlas sub-bitstream,
extent_config that is the decoder configuration record for the extent, and
config_property_index that may be set to a first value, for example 0, indicating that no property is associated with the extent, or may be a 1-based index (counting all boxes, including FreeSpace boxes) of the decoder configuration property box applying to this extent in the ItemPropertyContainerBox contained in the same ItemPropertiesBox. config_property_index should not be greater than the number of boxes contained in the associated ItemPropertyContainerBox. It is to be noted that variants with more or less bits may be used to represent the property index if needed, using flags or version of the box.

FIG. 6 illustrates another embodiment of a media file 135, using split sample boxes to encapsulate encoded volumetric bitstream, such as V3C, V-PCC or V-DMC.

In particular, Part-5 of the international standard for Coded representation of immersive media (MPEG-I), named “Visual volumetric video-based coding (V3C) and video-based point cloud compression (V-PCC)” specifies a generic mechanism for visual volumetric video coding, i.e. visual volumetric video-based coding. This standard is commonly denoted ISO/IEC 23090-5 or MPEG-I Part 5.

MPEG-I Part-5 defines V3C bitstreams. A V3C bitstream (visual volumetric video-based coding bitstream) is a sequence of bits that forms the representation of coded volumetric frames and associated data forming one or more Coded V3C Sequences (CVSs). The generic mechanism may be used by applications targeting volumetric content, such as point clouds, immersive video with depth, mesh representations of visual volumetric frames, etc.

MPEG-I Part-5 also comprises specific definitions dedicated to point clouds called V-PCC for Video-based Point Cloud Compression.

A second part of MPEG-I, Part-12 (ISO/IEC 23090-12) relates to volumetric media encoded as MPEG Immersive Video (MIV) that can also be described within the generic V3C bitstream structure.

Part 29 of MPEG-I, named “Video-based dynamic mesh coding (V-DMC)” specifies syntax, semantics, and decoding for video based dynamic mesh coding (V-DMC) methods. Part 29 of MPEG-I defines V-DMC bitstreams. The syntax and semantics for Part 29 of MPEG-I are specified as an extension of Part-5. In particular, Part 29 of MPEG-I specifies processes that may be needed for reconstruction of visual volumetric media and may also include additional processes such as post decoding, pre-reconstruction, post reconstruction, and adaptation.

V3C bitstream allows mixing several kinds of bitstreams or sub-bitstreams: for example, atlas sub-bitstream with video sub-bitstreams (for geometry, attributes and occupancy). Besides, V-DMC defines additional types of bitstreams or sub-bitstreams.

As an example, V-DMC is considering additional sub-bitstreams, a base mesh (also named “basemesh”) sub-bitstream (or component) and optionally a displacement sub-bitstream. The base mesh sub-bitstream is a simplified low-resolution approximation of an original mesh, and the displacement sub-bitstream provides displacement vectors, to refine the base mesh to better fit the original mesh. Encoding of the displacement sub-bitstream is specified either using any video codec (such as HEVC, VVC for example) or arithmetic codec (for example as specified in Annex J of MPEG-I Part-29).

For base mesh sub-bitstream, V-DMC specification introduces new bitstream format. This new bitstream format, as for video coding format such as HEVC or the atlas sub-bitstream used in V3C, also uses NAL (Network Abstraction Layer) units. High Level Syntax (HLS) structures or syntax structures such as base mesh sequence parameter sets (BMSPS), base mesh frame parameter sets (BMFPS), or a sub mesh (also named “submesh”) layer raw byte sequence payload (RBSP) syntax structure representing the content of some of the NAL units of a V-DMC bitstream are also specified.

The embodiment of the media file 135 shown in FIG. 6 enables to encapsulate split layers corresponding in that case to V3C units, which contain sub-bitstreams encoded with different types of codecs. For example, a sub-bitstream is a base mesh sub-bitstream encoded with specific codec and another sub-bitstream is a displacement sub-bitstream encoded with another codec.

A split layer is a part of a sample. A split layer may correspond to a base split layer or to an additional split layer. For example an additional split layer may be associated with an enhancement layer or one or more tiles for example. An enhancement layer is a layer that enhances a base split layer (in quality, temporal resolution or spatial resolution or a combination of those for video streams).

A base split layer is a split layer that corresponds to the sample data described by existing ISOBMFF structures (sample size, chunk offset, sample to chunk). The base layer comprises the parts of the samples corresponding to the base split layer.

An additional split layer: (or complementary) is a split layer corresponding to the sample data described by additional ISOBMFF structures than the classical sample description. The data of an additional split layer correspond to additional data to the base data. An additional layer comprises the parts of the samples corresponding to an additional split layer.

The embodiment of the media file 135 shown in FIG. 6 also enables providing decoder configurations information for each split layer. For the description of this figure, split layer may correspond to and also be called V3C unit or sub-bitstream.

The decoder configuration of the sub-bitstream can be used by a decoder to identify the codec type and the different parameters sets information present in the sub-bitstream.

In FIG. 6, a one-by-one configuration decoder configuration is supposed, with one base split layer and three additional split layers (m=n=4).

The media file 900 comprises two boxes 902 and 920. Box 902 is a container of all the metadata boxes describing the encoded media data. More specifically in this example, box 902 is a movie box (‘moov’) describing a time sequence of volumetric encoded data.

Box 920 is a media data box (‘mdat’) which contains the data of the V3C Units. In this embodiment, the media data box 920 includes two chunks 920-1 and 920-2, as an example. Each chunk includes one or more samples of data that corresponds to a set of V3C units (for example m V3C units 916-1, 916-2, 916-3, 916-m). Each of these V3C units corresponds to a sub-bitstream encoded with a specific encoder, and is composed of a V3C header (represented as first dark gray part of data blocks 916-1 to 916-m) and a set of NAL units (represented by textured parts of data blocks 916-1 to 916-m) representing one or more samples of the encoded sub-bitstream. In particular, the V3C header of a sub-bitstream is disposed upstream of the NAL units of this sub-bitstream. A V3C header may contain a V3C unit length, in bytes, followed by a v3c_unit_header syntax element as defined in ISO/IEC 23090-5 or derived specifications.

The movie box 902 includes among others boxes a track box 903 ‘trak’. The track box 903 carries temporal and spatial information, pertinent to decode, access and locate the media data samples stored in the media data box 920. In particular, the track box 903 includes a sample table box 904 (‘stbl’) carrying structures describing the samples.

The sample table box 904 includes a box 906, notably a sample to chunk box (‘stsc’). Box 906 contains information to find the chunk that contains a sample, its position, and the associated sample entry.

The sample table box 904 also includes a box 908, notably a chunk offset box (‘stco’) or a chunk large offset box (‘co64’) (alternative not represented). The box 908 contains information giving the offset of the start of each chunk into the data part 920 of the containing file.

The sample table box 904 also includes a box 910, notably a sample size box (‘stsz’). The box 910 contains the number of samples composing the base split layer and a table giving the size of each sample of the base split layer. This size of each sample of the base split layer can be expressed in bytes.

The sample table box 904 also includes a box 922, called for example a split sample layer configuration box (‘sslc’), with a number of additional split layers equal to 3 (num_split_layers=3). This box 922 provides information for all boxes describing split layers, at least the number of additional split layers and their relative order.

The sample table box 904 also includes a box 905, notably a sample description box (‘stsd’), that contains a base split layer sample entry 912-1, here corresponding to a V3C bitstream sample entry (‘v3e1’).

The base split layer sample entry 912-1 contains a decoder configuration box 914-1, notably a V3C configuration box (‘v3cC’), including decoder configuration for initializing a decoder to decode part 916-1 of the sample(s). In case of volumetric encoded data, it enables to decode the atlas sub-bitstream.

The base split layer sample entry 912-1 contains also a box 924, notably a split sample descriptions box (‘sshd’), including decoder configuration of the additional split layers, containing up to num_split_layers sample entries.

The split sample descriptions box 924 includes a sample entry 912-2, indicating samples from a V3C single track (for example ‘vdm1’). This sample entry includes a box 914-2, notably a V-DMC base mesh configuration box (‘vbmC’), comprising decoder configuration for initializing a decoder to decode part 916-2 of the sample, corresponding to a base mesh sub-bitstream.

The split sample descriptions box 924 includes another sample entry 912-3, notably a HEVC sample entry (‘hvc1’). This sample entry includes a box, notably a HEVC configuration box (‘hvcC’), comprising decoder configuration for initializing a decoder to decode part 916-3 of the sample, corresponding to a geometry video sub-bitstream, which provides displacement information applicable to the base mesh.

The split sample descriptions box 924 also includes a sample entry 912-n, notably a HEVC sample entry (‘hvc1’). This sample entry 912-n includes a different box 914-n, notably an HEVC configuration box” (‘hvcC’), comprising decoder configuration for initializing a decoder to decode part 916-m of the sample, corresponding for example to an attribute video sub-bitstream, such as a texture.

The sample table box 904 also includes a box 926, notably a split sample sizes box (‘ssss’). The box 926 contains for each additional split layer a box, notably a sample size box (or its compact version ‘stz2’), indicating the sizes of the different split layer samples. For example, one for indicating the sample sizes of 916-2 (in 920-1 and 920-2), one for the sample sizes of 916-3 and one for the sample sizes of 916-m.

In another embodiment, when a same decoder configuration applies to several sub-bitstreams, a V3C bitstream sample entry describing one of these sub-bitstreams uses an indication to identify the sub-bitstream sample entry providing the decoder configuration. In a variant, a V3C bitstream sample entry may use an additional mapping information (e.g. a box in the sample description) for associating decoder configuration with a sub-bitstream (or split sample).

In an embodiment, the indication may be a flag indicating to use the same decoder configuration as the previous sub-bitstream sample entry.

In another embodiment, the indication may be an index indicating the sub-bitstream sample entry that contains the decoder configuration to apply.

In another embodiment, the indication may be a flag indicating that additional mapping element is provided to determine the decoder configuration and an index indicating in the mapping element the decoder configuration to be used.

FIG. 7 illustrates another embodiment of a media file 135, using split sample boxes to encapsulate encoded volumetric bitstream, such as V3C, V-PCC or V-DMC.

Such embodiment of a media file enables to encapsulate split layers corresponding in that case to the NALU-based sub-bitstreams contained in V3C units.

As for embodiment of FIG. 6, the media file enables to provide decoder configurations information for each split layer, but with a finer level.

In FIG. 7, a one-by-one configuration decoder configuration is supposed, with one base split layer and three split layers (n=m=4). In particular, the base split layer can be an atlas sub-bitstream, and the additional split layers can be a base mesh sub-bitstream or a geometry or attribute video encoded sub-bitstream.

The description 1000 comprises two boxes 1002 and 1020. Box 1002 is a container of all the metadata boxes describing the encoded media data. More specifically in this example, the box 1002 is notably a movie box (‘moov’) describing a time sequence of volumetric encoded data.

Box 1020 is notably a media data box (‘mdat’). Box 1020 contains the data of each sub-bitstream contained in V3C Units. In this embodiment, box 1020 includes different chunks, each chunk including one or more contiguous parts of samples of one or more NAL units corresponding to a sub-bitstream. For example:
chunk 1016-1 represents one or more samples of one or more NAL units corresponding to an atlas sub-bitstream,
chunk 1016-2 represents one or more samples of one or more NAL units s corresponding to a base mesh sub-bitstream,
chunk 1016-3 represents one or more samples of one or more NAL units corresponding to a geometry video encoded sub-bitstream, (another example could be an arithmetic coded displacement sub-bitstream)
chunk 1016-m represents one or more samples of one or more NAL units corresponding to an attribute video encoded sub-bitstream.

The movie box 1002 includes among others boxes a box 1003, notably a track box (‘trak’). The box 1003 carries temporal and spatial information, pertinent to decode, access and locate the media data samples stored in the media data box. In particular, the track box includes a sample table box 1004 (‘stbl’) carrying the structures describing the samples.

The sample table box 1004 includes a box 1006, notably a sample-to-chunk box ‘stsc’. The box 1006 contains information to find the chunk that contains a sample and its position.

The sample table box 1004 includes a box 1008, notably a chunk offset box (‘stco’) or chunk large offset box (‘co64’) (alternative not represented). The box 1008 that contains information giving the index of each chunk into the containing file, for the base split layer.

The sample table box 1004 includes a box 1010, notably a sample size box (‘stsz’ or its compact version ‘stz2’). The box 1010 contains the number of samples composing the base split layer and a table giving the size of each sample for this base split layer. This size of each sample of the base split layer can be expressed in bytes.

The sample table box 1004 includes a box 1022, notably a split sample layer configuration box (‘sslc’), with a number of split layers equal to 3 (num_split_layers=3). This box provides information for all boxes describing additional split layers, at least the number of split layers and their relative order.

The sample table box 1004 includes a box 1005, notably a sample description box (‘stsd’). The box 1005 contains a base split layer sample entry 1012-1, notably a V3C bitstream sample entry type (e.g. ‘v3e1’) indicating a single track encapsulation.

The base split layer sample entry 1012-1 contains a box 1014-1, notably a V3C configuration box” (‘v3cC’), comprising a decoder configuration for initializing a decoder to decode part 1016-1 of the sample(s). In case of volumetric encoded data, the decoder configuration 1014-1 enables to decode Atlas sub-bitstream.

The base split layer sample entry 1012-1 also contains an additional box 1032-1, for example called sub-bitstream unit header box (‘sbuh’), which stores the information to identify the type of sub-bitstream described. This information is also necessary to re-generate the V3C bitstream. This generation consists, on a sample basis, in reaggregating NAL units of the sub-bitstreams into V3C units prefixed by a V3C unit length and a v3c_unit_header.

In an embodiment, the sub-bitstream unit header box 1032-1 (‘sbuh’) is equivalent to a box V3C unit header box (‘vunt’) of the standard ISO/IEC 23090-10 and stores the content of a V3C unit header syntax element. A sub-bitstream unit header box (e.g. 1032-1) (‘sbuh’) may further contain the nal_unit_size_precision syntax element defined in ISO/IEC 23090-5 or derived specifications, corresponding to the NAL units of the associated sub-bitstream (e.g. 1016-1) if not available in the associated decoder configuration (e.g. 1014-1).

The base split layer sample entry 1012-1 also contains a split sample description box 1024 (‘sshd’) to provide the decoder configurations of the additional split layers, containing up to num_split_layers sample entries.

The split sample description box 1024 includes a sample entry 1012-2, notably a V3C bitstream sample entry (‘vdm1’). The sample entry 1012-2 includes a box 1014-2, notably a V-DMC base mesh configuration box (‘vbmC’), comprising decoder configuration for initializing a decoder to decode NAL samples 1016-2 of a base mesh sub-bitstream.

The split sample descriptions box 1024 also includes another sample entry 1012-3, notably a HEVC sample entry (‘hvc1’), including a box 1014-3, notably a HEVC configuration box (‘hvcC’), comprising a decoder configuration for initializing a decoder to decode NAL units 1016-3 of a geometry video sub-bitstream, for example providing displacement information applicable to the base mesh.

The split sample descriptions box 1024 includes a sample entry 1012-n, notably a HEVC sample entry (‘hvc1’), including a different box 1014-n, notably a “HEVC configuration box” (‘hvcC’), comprising decoder configuration for initializing a decoder to decode NAL units 1016-m of an attribute video sub-bitstream, such as a texture.

As for base split layer, each of these sample entries 1012-2, 1012-3, 1012-n may also include an additional box, notably a sub-bitstream unit header box (as for example 1032-2, 1032-n), that stores the information to identify the type of sub-bitstream described in the sample entry.

The sample table box 1004 also includes a box 1026, notably a split sample sizes box” (‘ssss’). The box 1026 contains for each additional split layer a box, notably a sample size box (or its compact version ‘stz2’), indicating the sizes of the different split layer samples. For example, one sample size box is used for indicating the sample sizes of samples contained in chunk 1016-2, another sample size box is used for the sample sizes of samples contained in chunk 1016-3 and another sample size box is used for the sample sizes of samples contained in chunk 1016-m.

The sample table box 1004 also includes a box 1028, notably a split samples offset box (‘ssco’) 1028, that contains, for each additional split layer, a box, notably a chunk offset box (or a chunk large offset box), indicating an offset of a chunk as 1016-1, 1016-2, 1016-3 or 1016-m in the media data 1020 (‘mdat’), where a part of a sample may be found. In this particular data organization, a part of a sample (a split-layer) corresponds to the NAL units of one or more frames of a given V3C unit type, this V3C unit type being indicated in the sample entry for this part of sample (also called split-layer).

Specifically, in case of V3C bitstream, a V3C sample may consist in one or more consecutive frames of a 3D content by aggregating in a sample a group of consecutive encoded frames. When encapsulating as described, the group of frames information may be kept. This enables to regenerate the V3C bitstream with the same group of frames. There may be an interest in encapsulating samples as one frame, for example for fine grain temporal access in a V3C bitstream. Having a sample corresponding to one to several consecutive frames (e.g. a group of frames) depends on the configuration of the encapsulation module or on the application settings or user preferences.

In an embodiment, the sample table box 1004 also includes a box 1030, notably a sync sample box (‘stss’). The box 1030 stores an index of a sample corresponding to the first frame index contained in each group of frames. When performing the encapsulation, the first frame index of each group of frames is identified for each new V3C unit with vuh_unit_type=V3C_AD, after detection of a V3C unit with vuh_unit_type=V3C_VPS.

In another embodiment, when encapsulating the bitstream with a data organization as depicted on 1020, a new chunk may be created or each V3C sample, implicitly regrouping for each sub-bitstream, the NAL units corresponding to a group of frames. This preserves and provides a group of frames based access. Such organization, may be additionally indicated, for example in an extended version of the split layer configuration box 1022 as follow:

| SplitSampleLayerConfigBox extends FullBox('sslc’, 0, 0){ | |
|---|---|
| unsigned int(31) | num_split_layers; |
| unsigned int(1) | GOF_per_Chunk_flag; |

}

where GOF_per_Chunk_flag when set to 1 indicates that groups of frames of the encapsulated V3C bitstream are aligned with chunk boundaries, meaning that the compliant V3C bitstream can be regenerated by starting a new group of frames at each new chunk, otherwise the flag is set to 0 indicating that groups of frames are not aligned with chunk boundaries.

In that case, for reconstructing a compliant V3C bitstream from the split sample description, additional signaling in SplitSamplesConfigurationBox may be necessary. It may for example consist in redefining the reserved value 3 of single_base_compatible, as follow:
3: the sample can be reaggregated to be compliant to the associated sample entry type, by preceding each set of samples by the content of the sub-bitstream unit header box 1032-1.

In a variant, the reserved value 3 of single_base_compatible, can be defined as follow:
3: the sample can be reaggregated to be compliant to the associated sample entry type, following the rule predefined by the coding format indicated by the sample entry type. For instance, if the sample entry type (e.g. ‘vdm1’) indicates a V-DMC coding format, the predefined rule can be that each set of samples has to be prefixed by the content of the sub-bitstream unit header box 1032-1. This content may provide a number of bytes used to encode the NAL unit length prefixing each NAL unit in the corresponding split layer chunk (1016-1 for example for the ‘sbuh’ box 1032-1) if this number of bytes is not already indicated in a decoder configuration (1014-1). For the sake of clarity, while only one occurrence of each chunk 1016-1 to 1016-m is represented, each may repeat along time for V3C sequences where a chunk defines a given time interval in this sequence and not the complete V3C sequence. The description for split samples, for configuration information and for sub-bitstream unit header box also apply to these other chunk occurrences.

It is to be noted that FIG. 7 defines split sample offsets in box 1028 which allows having chunk offset per split-layer, offering more flexibility in the data organization than a single ‘stco’ box as in FIG. 6. It is to be noted that such box 1028 can apply to the configuration in FIG. 6 to also offer more flexibility in the storage of V3C units in the data part of the file. For example, with a box 1028 in box 904, there could be as chunk offset boxes as additional split layers. Then, the chunks 920-1 and 920-2 would become chunks corresponding to a set of consecutive V3C units of a same type, for example these chunk offset boxes in box 1028 would provide offsets to parts 916-1 to 916-m.

Example of Hardware to Carry Out Steps of the Encoding Method and/or the Decoding Method

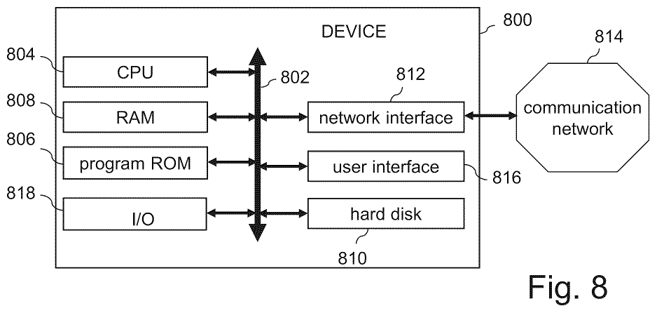

FIG. 8 is a schematic block diagram of a computing device 800 for implementing at least a part of one or more embodiments of the disclosure. The computing device 800 may be a device such as a micro-computer, a workstation or a light portable device. The computing device 800 comprises a communication bus 802 connected to one, several or all the following elements:
a central processing unit 804, such as a microprocessor, denoted CPU;
a random access memory 808, denoted RAM, for storing the executable code of at least a part of the method of embodiments of the disclosure as well as the registers adapted to record variables and parameters necessary for implementing the method according to embodiments of the disclosure, the memory capacity thereof can be expanded by an optional RAM connected to an expansion port for example;
a read only memory 806, denoted ROM, for storing computer programs for implementing embodiments of the disclosure;
a network interface 812 that may be connected to a communication network over which digital data to be processed may be transmitted or received. The network interface 812 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 804;
a graphical user interface 816 may be used for receiving inputs from a user or to display information to a user;
a hard disk 810 denoted HD may be provided as a mass storage device; and
an I/O module 818 may be used for receiving/sending data from/to external devices such as a 3D mediadata source or display.

The executable code may be stored either in read only memory 806, on the hard disk 810 or on a removable digital medium such as for example a disk. According to a variant, the executable code of the programs can be received by means of the communication network 814, via the network interface 812, in order to be stored in one of the storage means of the communication device 800, such as the hard disk 810, before being executed.

The central processing unit 804 is adapted to control and direct the execution of the instructions or portions of software code of the program or programs according to embodiments of the disclosure, which instructions are stored in one of the aforementioned storage means. After powering on, the CPU 804 is capable of executing instructions from main RAM memory 808 relating to a software application after those instructions have been loaded from the program ROM 806 or the hard-disc (HD) 810 for example. Such a software application, when executed by the CPU 804, causes steps of the flowcharts of the disclosure to be performed.

Any step of the algorithms of the disclosure may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present disclosure has been described hereinabove with reference to specific embodiments, the present disclosure is not limited to the specific embodiments, and modifications will be apparent to a skilled person in the art which lie within the scope of the present disclosure.

Many further modifications and variations will suggest themselves to those versed in the art upon making reference to the foregoing illustrative embodiments, which are given by way of example only and which are not intended to limit the scope of the disclosure, that being determined solely by the appended claims. In particular the different features from different embodiments may be interchanged, where appropriate.

Each of the embodiments of the disclosure described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulating a visual volumetric data bitstream into a media file, in a processing device, the visual volumetric data bitstream comprising a plurality of encoded sub-bitstreams corresponding to a plurality of components of the visual volumetric data, the method comprising:
generating a single entity comprising the plurality of encoded sub-bitstreams;
generating at least two decoder configuration data structures; and
generating a media file comprising the generated single entity, the at least two decoder configuration data structures and an indication for indicating whether at least one of the decoder configuration data structures is associated with an encoded sub-bitstream comprised in the single entity based on association information.

2. The method of claim 1, wherein the indication further indicates whether each of the decoder configuration data structures is associated with an encoded sub-bitstream of the plurality, based on a predetermined order depending on a type of the encoded sub-bitstream, such that the indication indicates whether each of the decoder configuration data structures is associated with an encoded sub-bitstream of the plurality based on association information or on a predetermined order depending on a type of the encoded sub-bitstream.

3. The method of claim 1, wherein the media file further comprises an association structure comprising the association information for associating at least one of the at least two decoder configuration data structures with an encoded sub-bitstream of the plurality.

4. The method of claim 3, wherein the association information comprises an index of a decoder configuration data structure associated with a header of the visual volumetric data bitstream describing a sub-bitstream.

5. The method of claim 3, wherein the indication for indicating that the at least one decoder configuration data structures is associated with an encoded sub-bitstream based on association information is the presence of the association structure.

6. The method of claim 1, wherein the single entity is a track and the association information is comprised in the track.

7. The method of claim 6, wherein the at least two decoder configuration data structures and the association structure are comprised in a sample entry of the track.

8. The method of claim 1, wherein the single entity is an item and the association information is associated with the item.

9. The method of claim 3, wherein the single entity is an item and the association information is associated with the item and wherein the item is associated with a plurality of decoder configuration data structures and the association structure as item properties.

10. A method of processing a media file encapsulating a visual volumetric data bitstream, in a processing device, the visual volumetric data bitstream comprising a plurality of encoded sub-bitstreams corresponding to a plurality of components of visual volumetric data of the visual volumetric data bitstream, the method comprising:
obtaining, from the media file,
(i) a single entity comprising the plurality of encoded sub-bitstreams,
(ii) at least two decoder configuration data structures and
(iii) an indication for indicating whether at least one of the decoder configuration data structures is associated with an encoded sub-bitstream comprised in the single entity based on association information; and
associating decoder configuration data to each sub-bitstream of the plurality based on the obtained at least two decoder configuration data structures and the indication.

11. The method of claim 10, wherein the indication further indicates whether each of the decoder configuration data structures is associated with an encoded sub-bitstream of the plurality, based on a predetermined order depending on a type of the encoded sub-bitstream, such that the indication indicates whether each of the decoder configuration data structures is associated with an encoded sub-bitstream of the plurality based on association information or on a predetermined order depending on a type of the encoded sub-bitstream.

12. The method of claim 10, further comprising obtaining, from the media file, an association structure comprising the association information for associating at least one of the decoder configuration data structures with an encoded sub-bitstream of the plurality.

13. The method of claim 12, wherein the indication for indicating that the at least one decoder configuration data structure is associated with an encoded sub-bitstream based on association information is the presence of the association structure.

14. The method of claim 10, wherein the single entity is a track and the association information is comprised in the track.

15. The method of claim 14, wherein the at least two decoder configuration data structures and the association structure are comprised in a sample entry of the track.

16. The method of claim 10, wherein the single entity is an item and the association information is associated with the item.

17. The method of claim 12, wherein the single entity is an item and the association information is associated with the item and wherein the item is associated with a plurality of decoder configuration data structures and the association structure as item properties.

18. The method of claim 1, wherein the media file is an ISOBMFF media file.

19. A media file encapsulating a visual volumetric data bitstream, the visual volumetric data bitstream comprising:
a plurality of encoded sub-bitstreams corresponding to a plurality of components of the visual volumetric data, the media file comprising a single entity, the single entity comprising a plurality of encoded sub-bitstreams, the media file further comprising at least two decoder configuration data structures and an indication for indicating whether at least one of the decoder configuration data structures is associated with an encoded sub-bitstream based on association information.

20. A non-transitory computer-readable storage medium storing instructions of a computer program for implementing the steps of the method according to claim 1.

21. A processing device comprising a processing unit configured for carrying out each of the steps of the method according to claim 1.
